(19) United States
(12) Patent Application Publication
(10) Pub. No.: US 2024/0318427 A1
(43) Pub. Date: Sep. 26, 2024

(54) CROSS-LAMINATED TIMBER PANELS

(71) Applicant: CETRES HOLDINGS, LLC, JACKSON, WY (US)

(72) Inventor: Thomas M. ESPINOSA, Snohomish, WA (US)

(21) Appl. No.: 18/733,558

(22) Filed: Jun. 4, 2024

Related U.S. Application Data
(62) Division of application No. 17/514,202, filed on Oct. 29, 2021.
Application No. 17/514,202 is a division of application No. 16/780,472, filed on Feb. 3, 2020.
(60) Provisional application No. 62/800,966, filed on Feb. 4, 2019.

(51) Int. Cl. E04C 2/40; B32B 3/08; B32B 3/14; B32B 3/18; B32B 3/26; B32B 3/30; B32B 5/02; B32B 7/08; B32B 7/12; B32B 21/02; B32B 21/08; B32B 21/13; B32B 21/14; E04B 1/10; E04B 5/43; E04B 5/48; E04C 2/00; E04C 2/12; E04C 2/14; E04C 2/24; E04C 2/52

(52) U.S. Cl. CPC E04C 2/40; B32B 3/08; B32B 3/14; B32B 3/18; B32B 3/26; B32B 3/30; B32B 5/02; B32B 7/08; B32B 7/12; B32B 21/02; B32B 21/08; B32B 21/13; B32B 21/14; E04B 1/10; E04B 5/43; E04B 5/48; E04C 2/12; E04C 2/14; E04C 2/24; E04C 2/521; E04C 2/526; B32B 2419/00; B32B 2607/00; E04C 2002/002; Y10T 428/24066; Y10T 428/24132; Y10T 428/24562; Y10T 428/24744; Y10T 428/249923

(57) ABSTRACT

A cross-laminated timber panel comprises a plurality of layers of lumber boards, each layer comprising a number of the lumber boards laid side-to-side pointing to a direction, each layer being disposed perpendicular to the direction of an adjoining layer; and an insert member replacing one of the lumber boards, the insert member having a different material or configuration than the lumber boards.

### RELATED APPLICATIONS

This is a divisional application of Nonprovisional application Ser. No. 17/514,202, filed Oct. 29, 2021, which is a divisional application of Nonprovisional application Ser. No. 16/780,472, filed Feb. 3, 2020, which is a nonprovisional application of Provisional Application Ser. No. 62/800,966, filed Feb. 4, 2019, and all the aformentioned applications are hereby incorporated by reference.

### FIELD OF THE INVENTION

The present invention is generally directed to cross-laminated timber (CLT) panels for use in walls and floors of a building subject to compression and tension loading.

### SUMMARY OF THE INVENTION

The present invention provides a cross-laminated timber panel, comprising a plurality of layers of lumber boards, each layer comprising a number of the lumber boards laid side-to-side pointing to a direction, each layer being disposed perpendicular to the direction of an adjoining layer; and an insert member replacing one of the lumber boards, the insert member having a different material or configuration than the lumber boards.

The present invention also provides a cross-laminated timber panel, comprising a plurality of layers of lumber boards, each layer comprising a number of lumber boards laid side-to-side pointing to a direction, each layer being disposed perpendicular to the direction of an adjoining layer; and one of the lumber boards including a first passageway.

The present invention further provides a cross-laminated timber panel, comprising a plurality of layers of lumber boards, each layer comprising a number of lumber boards laid side-to-side pointing to a direction, each layer being disposed perpendicular to the direction of an adjoining layer; a first passageway in a first layer; and a second passageway is disposed transverse to the first passageway to intersect and connect with the first passageway.

The present invention provides a building, comprising a lower cross-laminated timber (CLT) wall with a first insert member having a top end; a CLT floor disposed above the lower CLT wall; and an upper CLT wall disposed above the CLT floor, the upper CLT wall including a second insert member having a lower end engaging the top end of the lower CLT wall, thereby to transfer the load from upper CLT wall to the lower CLT wall via the first insert member and the second insert member.

The present invention also provides a cross-laminated timber panel, comprising a plurality of layers of lumber boards, each layer comprising a number of lumber boards laid side-to-side pointing to a direction, each layer being disposed perpendicular to the direction of an adjoining layer; and nail plates disposed between the layers to attach the layers to adjacent layers.

The present invention further provides a building, comprising a first wall made up of a plurality of layers of lumber boards, each layer comprising a number of lumber boards laid side-to-side pointing to a direction, each layer being disposed perpendicular to the direction of an adjoining layer, the first wall including a first insert member replacing one of the lumber boards, the first insert member having a greater compressive capacity than the lumber boards of the first wall; a floor made up of a plurality of layers of lumber boards, each layer comprising a number of lumber boards laid side-to-side pointing to a direction, each layer being disposed perpendicular to the direction of an adjoining layer, the floor being disposed above the first wall; a second wall made up of a plurality of layers of lumber boards, each layer comprising a number of lumber boards laid side-to-side pointing to a direction, each layer being disposed perpendicular to the direction of an adjoining layer, the second wall being disposed above the floor, the second wall including a second insert member having a greater compressive capacity than the lumber boards of the second wall; and the floor including a member disposed perpendicular to the floor, the member having a greater compressive capacity than the lumber boards of the floor, the member being aligned and in contact with the first insert member and the second insert member to transfer loading from the second wall to the first wall via the column insert member.

The present invention provides a building, comprising a first wall made up of a plurality of layers of lumber boards, each layer comprising a number of lumber boards laid side-to-side pointing to a direction, each layer being disposed perpendicular to the direction of an adjoining layer, the first wall including a first insert member replacing one of the lumber boards, the first insert member having a greater compressive capacity than the lumber boards of the first wall, the first insert member including a top end; a floor made up of a plurality of layers of lumber boards, each layer comprising a number of lumber boards laid side-to-side pointing to a direction, each layer being disposed perpendicular to the direction of an adjoining layer, the floor being disposed above the first wall; and a second wall made up of a plurality of layers of lumber boards, each layer comprising a number of lumber boards laid side-to-side pointing to a direction, each layer being disposed perpendicular to the direction of an adjoining layer, the second wall being disposed above the floor, the second wall including a second insert member having a greater compressive capacity than the lumber boards of the second wall, the second insert member including a lower end engaging the top end of the first insert member, thereby to transfer the load from the second wall to the first wall via the first insert member and the second insert member.

The present invention also provides a building, comprising a first wall made up of a plurality of layers of lumber boards, each layer comprising a number of lumber boards laid side-to-side pointing to a direction, each layer being disposed perpendicular to the direction of an adjoining layer; a floor made up of a plurality of layers of lumber boards, each layer comprising a number of lumber boards laid side-to-side pointing to a direction, each layer being disposed perpendicular to the direction of an adjoining layer, the floor being disposed above the first wall; a second wall made up of a plurality of layers of lumber boards, each layer comprising a number of lumber boards laid side-to-side pointing to a direction, each layer being disposed perpendicular to the direction of an adjoining layer, the second wall being disposed above the floor; the floor including an opening; and a first portion of the first wall supporting a second portion of the second wall through the opening.

The present invention further provides a building, comprising a) a first wall made up of a plurality of layers of lumber boards, each layer comprising a number of lumber boards laid side-to-side pointing to a direction, each layer being disposed perpendicular to the direction of an adjoining layer, the first wall including a top edge; a second wall made up of a plurality of layers of lumber boards, each layer comprising a number of lumber boards laid side-to-side pointing to a direction, each layer being disposed perpendicular to the direction of an adjoining layer, the second wall being disposed above the floor, the second wall including a bottom edge supported on the top edge of the first wall to define a combined wall; the combined wall including an opening; a floor made up of a plurality of layers of lumber boards, each layer comprising a number of lumber boards laid side-to-side pointing to a direction, each layer being disposed perpendicular to the direction of an adjoining layer; and the floor including a portion received in the opening, the floor including a slot or cutout on each side of the portion to receive the combined wall.

The present invention provides a building, comprising a lower stud wall; a floor made up of a plurality of layers of lumber boards, each layer comprising a number of lumber boards laid side-to-side pointing to a direction, each layer being disposed perpendicular to the direction of an adjoining layer, the floor being disposed above the first wall, the floor is disposed above the lower stud wall; an upper stud wall disposed above the floor; and the floor including a plurality of members extending through a thickness of the floor, the member having larger compressive capacities than the lumber boards of the floor, the members being aligned with the upper stud wall and the lower stud wall, thereby to transfer load from the upper stud wall to the lower stud wall through the members.

The present invention provides a building, comprising a lower stud wall including a top plate and vertical studs attached to the top plate; an upper stud wall including a bottom plate and vertical studs attached to the bottom plate; the bottom plate of the upper stud wall is disposed on the top plate of the lower stud wall; a horizontal member attached to the vertical studs; and a floor made up of a plurality of layers of lumber boards, each layer comprising a number of lumber boards laid side-to-side pointing to a direction, each layer being disposed perpendicular to the direction of an adjoining layer, the floor being disposed above the first wall, the floor is by the horizontal member.

The present invention also provides a building, comprising a foundation; a plurality of layers of lumber boards, each layer comprising a number of the lumber boards laid side-to-side pointing to a direction, each layer being disposed perpendicular to the direction of an adjoining layer; and an insert member replacing one of the lumber boards, the insert member having greater compressive strength than the lumber boards, the insert member including a bottom end operably supported by the foundation.

### BRIEF DESCRIPTION OF THE DRAWINGS

FIG. 1 is perspective view of a conventional cross-laminated timber (CLT) panel with several layers of lumber boards pressed and glued together.

FIGS. 2-12 are perspective views of a CLT wall which has been modified where at least one of the lumber board components is replaced with an insert member of a different characteristic, such as shape, material, strength, etc. in accordance with the present invention.

FIGS. 13-17 show the various ways of attaching the insert members to each other.

FIGS. 18A-19B show a CLT wall where the insert members are disposed on the outside layer.

FIGS. 20A-22B show a CLT wall with insert members attached to the outside layer, the insert members being used to attach the wall to a CLT floor panel.

FIGS. 23A-55B show various configurations of the insert members for providing passageways in the CLT wall.

FIGS. 54A-54B show the passageways being provided in the CLT floor panel.

FIGS. 55A-57C show CLT walls with insert members in the interior and outside layers.

FIGS. 58A-60C show ways of attaching lifting hardware to a CLT wall.

FIGS. 61A-65B show the use of nail plates to attach the insert members to the rest of the CLT lumber board components.

FIGS. 66A-73B show an upper CLT wall supported directly by a lower CLT wall without going through an intervening CLT floor panel, thus transferring load directly from the upper CLT wall to the lower CLT wall.

FIGS. 74A-74E show an upper stud wall supported by a lower stud wall without going through an intervening CLT floor panel.

FIG. 75 shows an upper stud wall supported directly by a lower stud wall without transferring load to a CLT floor panel supported by the lower CLT wall.

FIGS. 76A-80 show a CLT wall supported on a foundation.

### DETAILED DESCRIPTION OF THE INVENTION

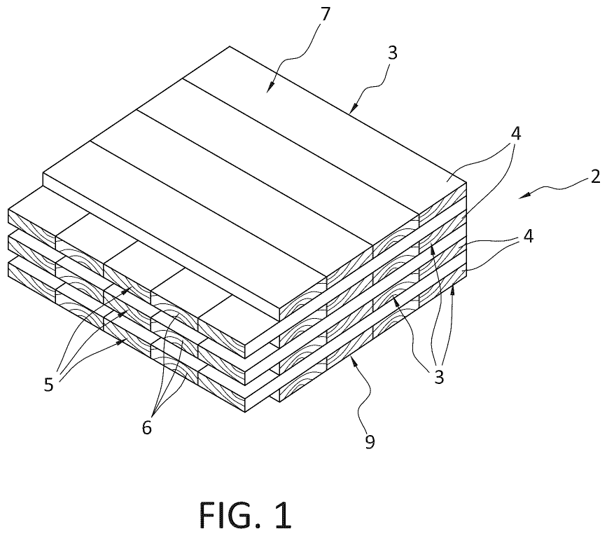

Referring to FIG. 1, a cross-laminated timber (CLT) panel 2 is a known product available in the market today. The CLT panel 2 is a large-scale, prefabricated, solid engineered wood panel. The CLT panel 2 consists of several layers 3 and 5 of kiln-dried lumber boards 4 and 6 stacked in alternating directions, bonded with structural adhesives, and pressed to form a solid, straight, rectangular panel. The lumber boards are made of the same type or species of wood, such as Douglas fir, white pine, southern yellow pine, etc. The lumber boards 4 are shown perpendicular to the lumber boards 6. The CLT panel 2 may be used as walls, floors, and roofs of a building.

The CLT panel 2 preferably consists of an odd number of layers, usually three to seven, with the outside layers 7 and 9 made of the lumber boards 4 running the same direction. CLT panels are exceptionally stiff, strong, and stable, handling load transfer on all sides.

The CLT panel 2 is lightweight yet very strong, with superior acoustic, fire, seismic, and thermal performance, proving to be a highly advantageous alternative to conventional materials like concrete, masonry, or steel, especially in multi-family and commercial construction. Finished CLT panels are typically 2 to 10 feet wide, with lengths up to 60 feet and thickness up to 20 inches. Widths up to 18 feet and lengths up to 98 feet are possible. For additional information, see, for example, https://www.apawood.org/cross-laminated-timber, hereby incorporated by reference.

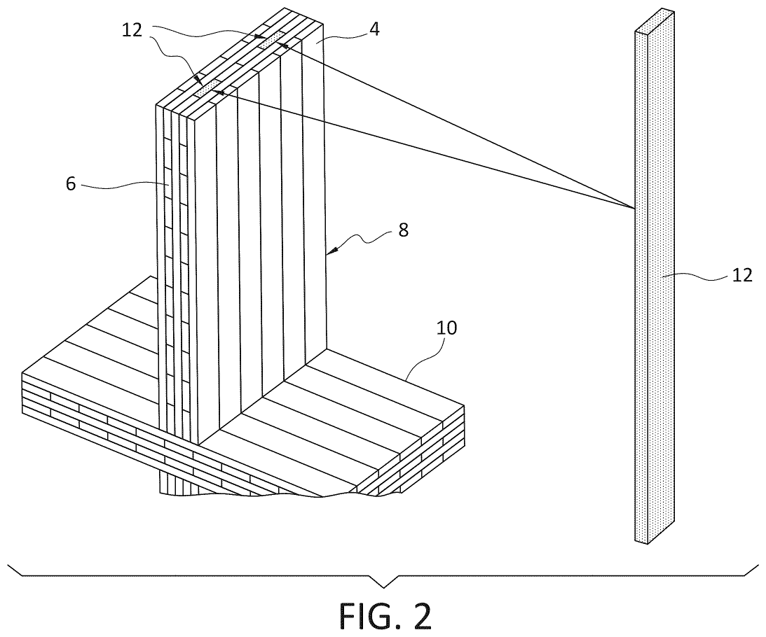

Referring to FIG. 2, a CLT panel 8 according to the present invention used as a wall in a building is shown attached to a CLT panel used as a floor 10, which may also incorporate the features of the CLT wall 8 according to the present invention. The CLT panel 8 is made by replacing one or more of the standard lumber boards 4 and/or 6 with an insert member 12, which may be solid or hollow and may be made of a material different from the other standard lumber boards that make up the rest of the CLT panel 8. The insert member 12 preferably may have different configuration or strength characteristics, such as greater compressive and tensile strength, than the lumber board it replaces. The insert member 12 has the same exterior dimensions as the lumber board it is replacing. The insert member 12 is glued, screwed or otherwise attached to the adjoining lumber boards during manufacture of the CLT panel 8.

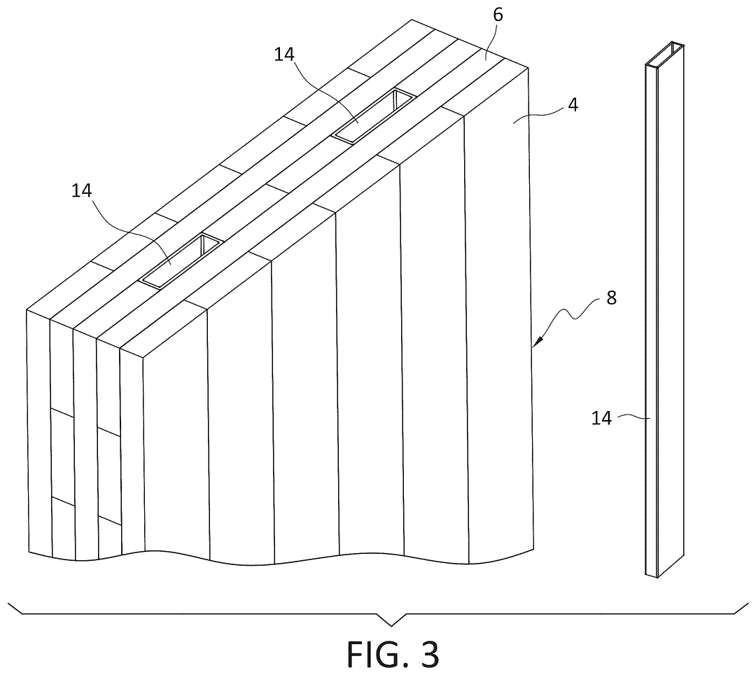

Referring to FIG. 3, the insert member 12 may be a rectangular tube 14, made of plastic, metal, such as aluminum, etc., replaces one or more of the standard lumber boards. The tube 14 has the same outside dimensions as the lumber board it replaces.

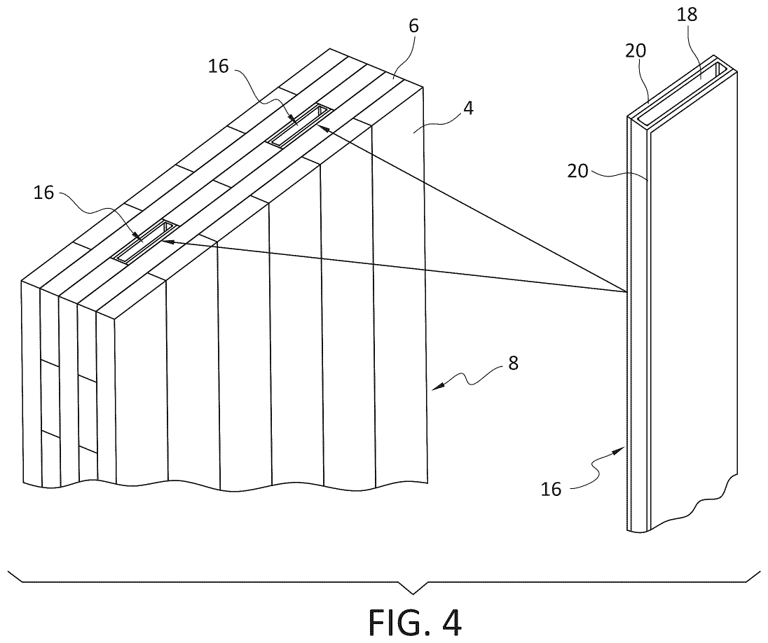

Referring to FIG. 4, the insert member 12 may be a member 16 made of a rectangular tube 18 with wood veneers 18 attached preferably to the two wider sides of the tube 18 is disclosed. The wood veneers 18 advantageously facilitate gluing of the member 16 to the other lumber boards in the CLT panel 8. The wood veneers 18 are attached to the two parallel sides of the tube 18. The member 16 has the same outside dimensions as the lumber board it replaces.

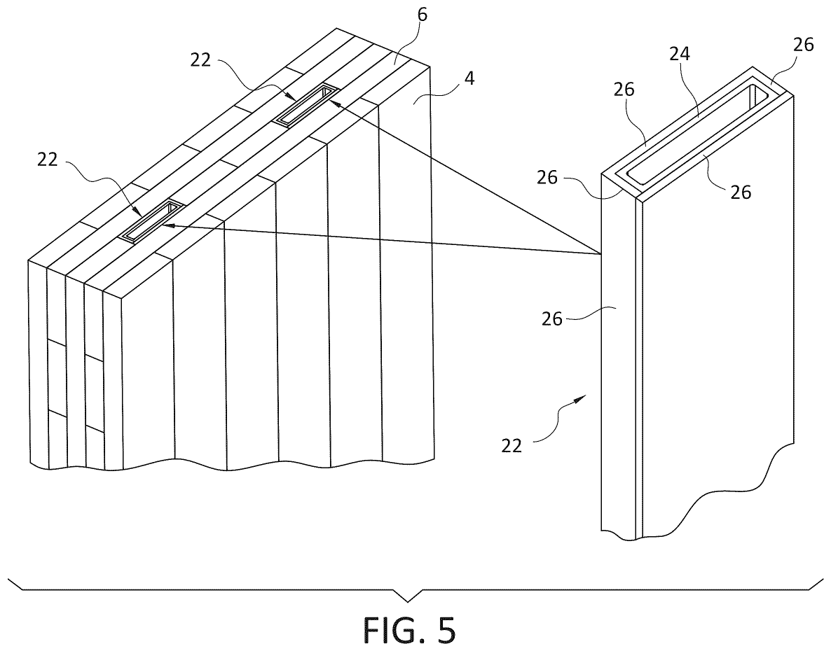

Referring to FIG. 5, the insert member 12 may be a member 22 made of a rectangular tube 24 with wood veneers 26 attached to all sides of tube 24 is disclosed. The wood veneers 26 advantageously facilitate gluing of the member 22 to the other lumber boards in the CLT panel 8. The member 22 has the same outside dimensions as the lumber board it replaces. The tube 24 may be made of plastic or metal such as aluminum.

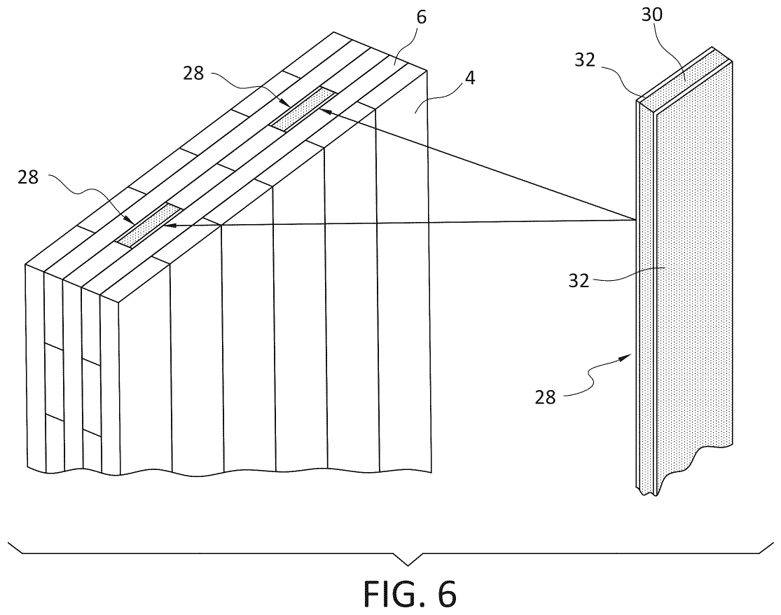

Referring to FIG. 6, the insert member 12 may be a member 28 made of a solid rectangular core 30 with wood veneers 32 attached preferably to the two wider sides of the core 30 disclosed. The wood veneers 32 advantageously facilitate gluing of the member 28 to the other lumber boards in the CLT panel 8. The member 28 has the same outside dimensions as the lumber board it replaces.

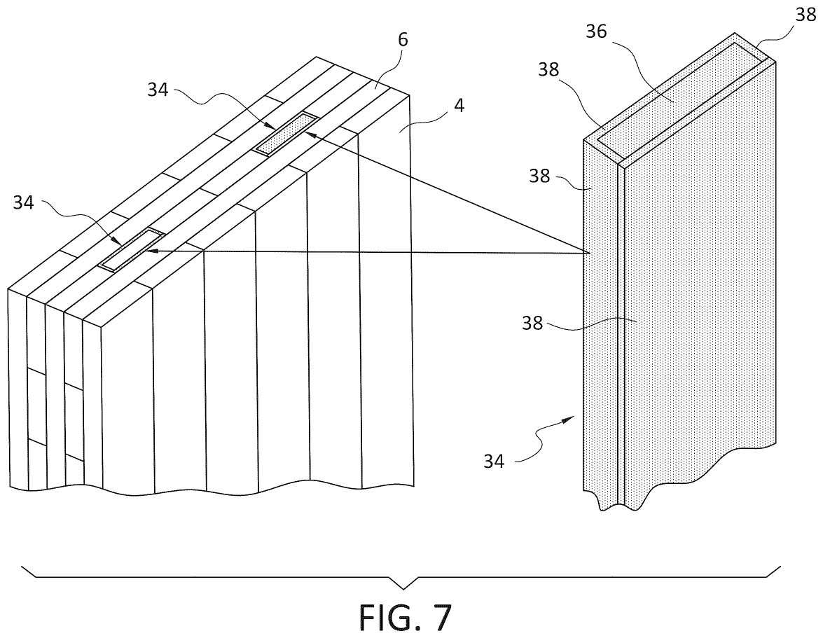

Referring to FIG. 7, the insert member 12 may be a member 34 made of a solid rectangular core 3 with wood veneers 38 attached to all sides of member 34 is disclosed. The wood veneers 38 advantageously facilitate gluing of the member 34 to the other lumber boards in the CLT panel 8. The member 34 has the same outside dimensions as the lumber board it replaces.

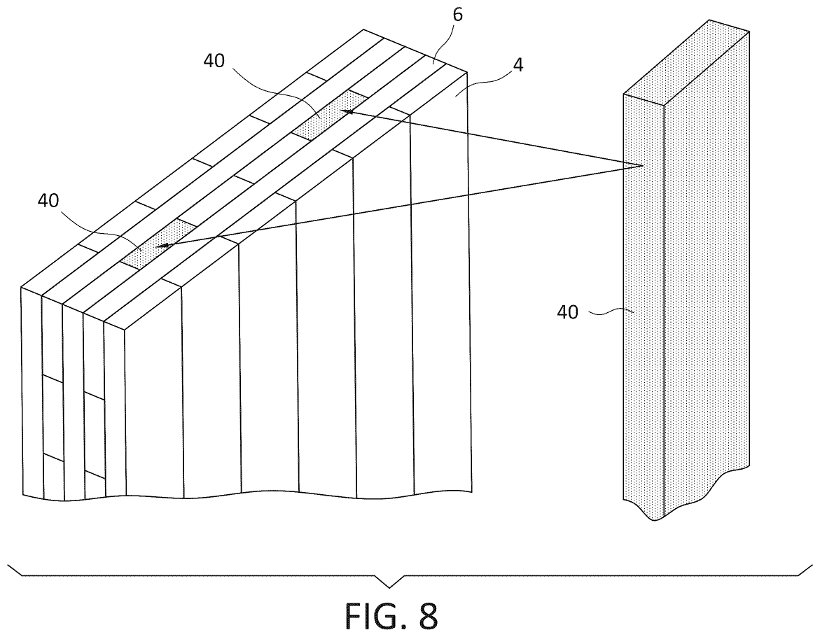

Referring to FIG. 8, the insert member 12 may be made of solid lumber 40 with different material properties, such as having greater compressive strength, than the lumber board it replaces.

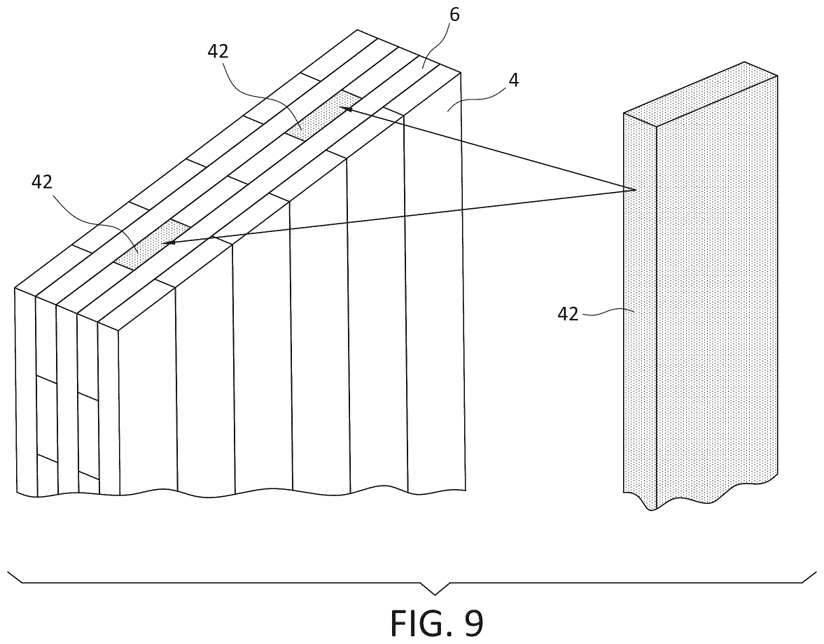

Referring to FIG. 9, the insert member 12 may be made of engineered lumber 42 with different material properties, such as having greater compressive strength, than the lumber board it is replacing. Engineered lumber, also called structural composite lumber (SCL) is well-known in the art. SCL includes laminated veneer lumber (LVL), parallel strand lumber (PSL), laminated strand lumber (LSL) and oriented strand lumber (OSL). The engineered lumber 42 out-performs conventional lumber when either face-or edge-loaded.

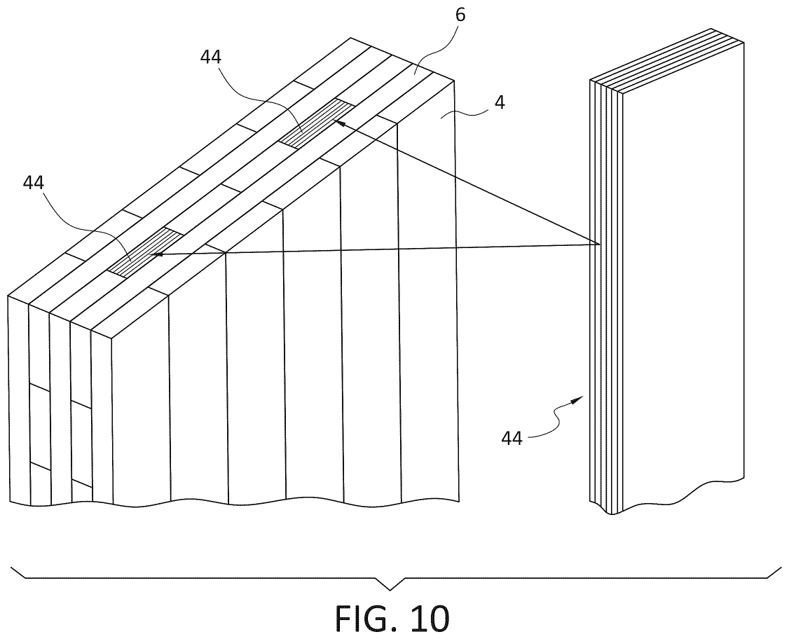

Referring to FIG. 10, the insert member 12 may be made of plywood 44 with different material properties, such as having greater compressive strength, than the lumber board it is replacing. Plywood is well-known in the art.

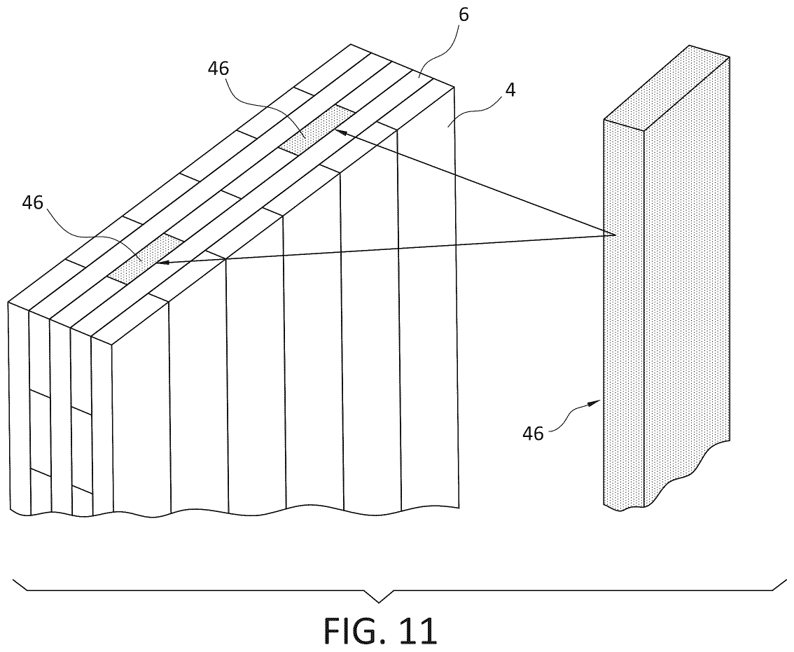

Referring to FIG. 11, the insert member 12 may be made of wood plastic composite 46 or carbon fiber block with different material properties than the lumber board it is replacing. Wood plastic composite or carbon fiber block are well-known in the art.

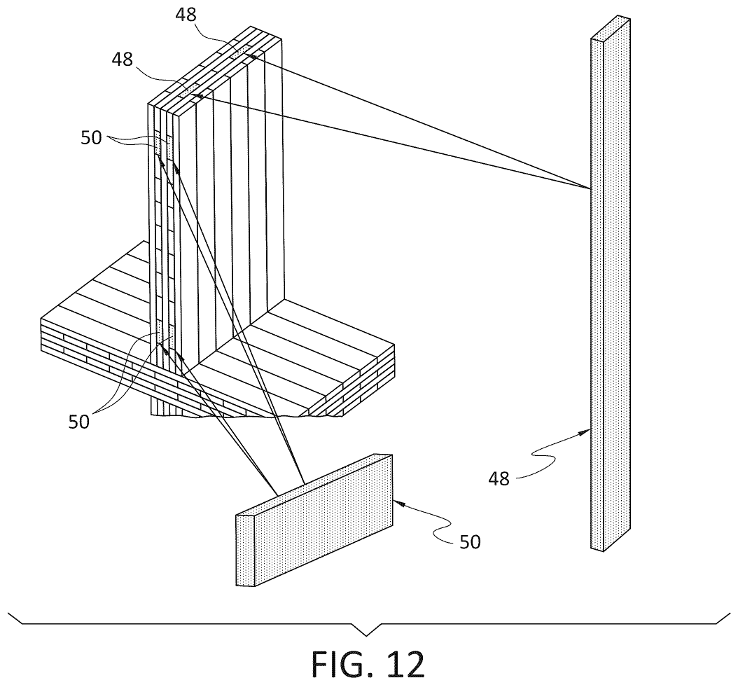

Referring to FIG. 12, the insert member 12, which may take any of the embodiments 14, 16, 22, 28, 34, 40, 42, 44 and 46 as shown in the previous figures is indicated as insert member 48 disposed in a vertical orientation. The insert member 12 with its various embodiments is indicated as insert member 50 disposed in a horizontal orientation. The insert member 48 replaces one or more of the standard lumber boards 4 from an inner or outer layer of the CLT panel, and the member 50 replaces one of more of the standard lumber boards 6 from an inner or outer layer. Accordingly, it should be understood that the insert member 12 and its various embodiments as insert members 14, 16, 22, 28, 34, 40, 42, 44 and 46 and other insert members disclosed herein are not limited to running in the same direction nor in the same layer. The various embodiments of the insert members 12 may be used as insert members 48 and 50 in various combinations.

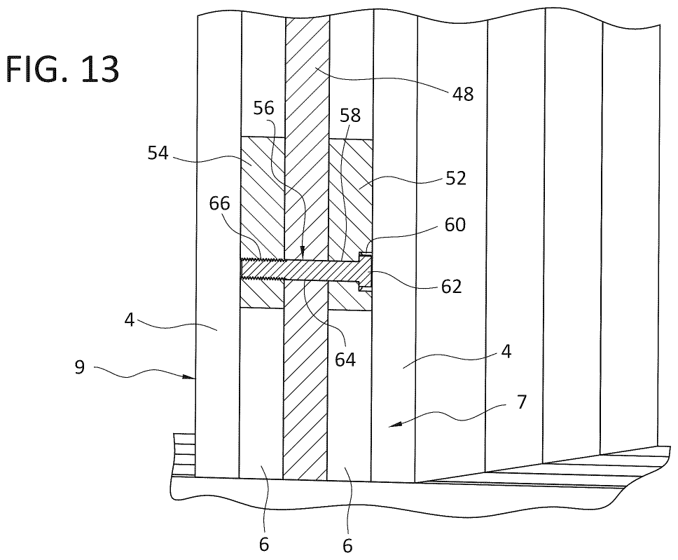

Referring to FIG. 13, the insert members 50 shown in FIG. 12 are represented as insert members 52 and 54. For the insert members 48, 52 and 54 that are solid (not hollow), the insert members 52 and 54 may be attached to the insert members 48 with a bolt 56. The insert member 52 has a through hole 58 with a counter-bored hole 60 so that the head 62 of the bolt is flush with the surface of the insert member 52. The insert member 48 has a through hole 64. The insert member 54 has a threaded hole 66 to which the bolt 56 is threaded. The bolt 56 is preferably installed prior to gluing and pressing the lumber boards together to form the CLT panel. The insert members 48, 52 and 54 are shown disposed in adjoining layers of the CLT panel, but they may also be disposed where they are separated by at least one layer of the lumber boards.

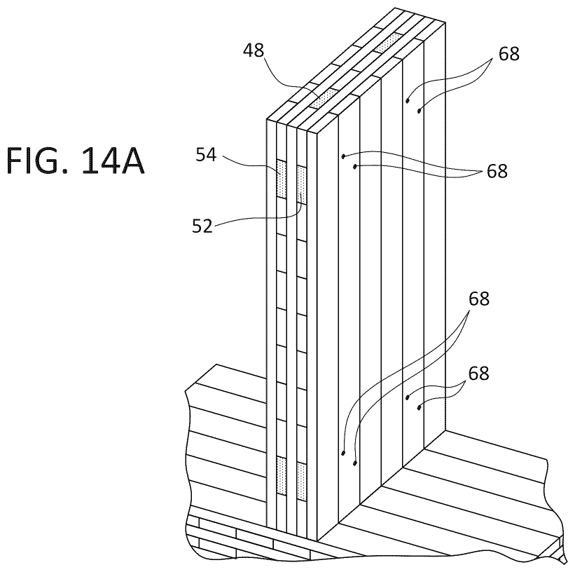

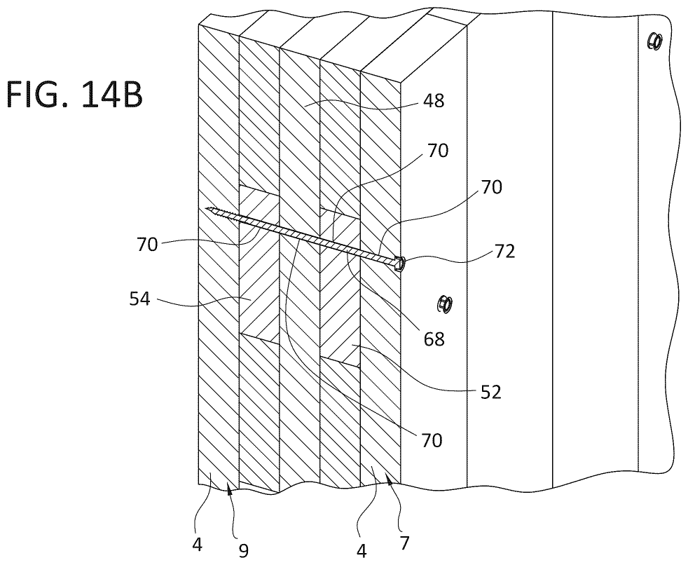

Referring to FIG. 14A, the insert member 48, 52 and 54 may also be attached to the CLT panel with screws 68, preferably two at each intersection of the insert member 48 with the insert members 52 and 54, vertically staggered from each other.

Referring to FIG. 14B, the screws 68 extend from the face of the outside layer 7 to the opposite outside layer 9. Through holes 70 are provided in the insert members 48, 52 and 54 and the lumber board 4 of the outside layer 7. The screw is threaded into the opposite lumber 4 of the outside layer 9. A counter-bore 72 may be provided in the through hole 70 in the outer lumber board 4 of the outside layer 7 so that the screw head is flush with or recessed below the face of the outer lumber board 4.

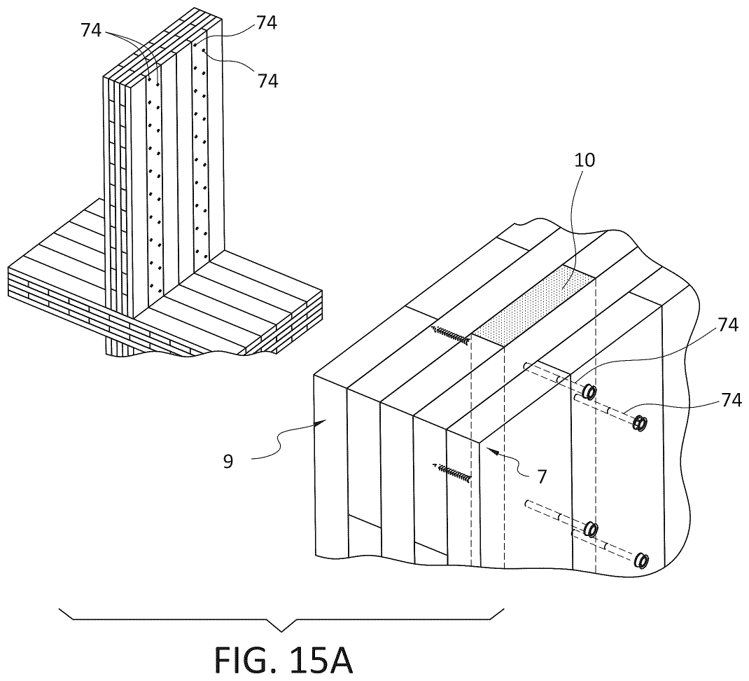

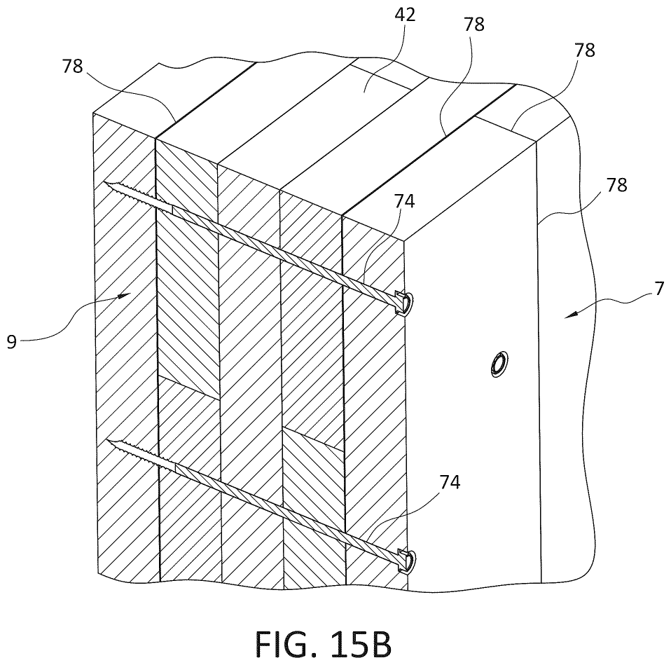

Referring to FIGS. 15A and 15B, the insert member made of engineered lumber 42 may be attached with screws 74 to the neighboring lumber boards of the CLT panel. The screws 74 are attached through the outside layer 7. The screws 74 are arranged in columns, two columns per insert member 42 and the two columns are staggered or shifted vertically from each other. Glue between the adjoining surfaces 78 of the lumber boards 4 and 6 join the lumber boards 4 and 6 together. The screws 74 may be countersunk into the face of the outside layer 7. The screws 74 may stop short of the outside layer 9.

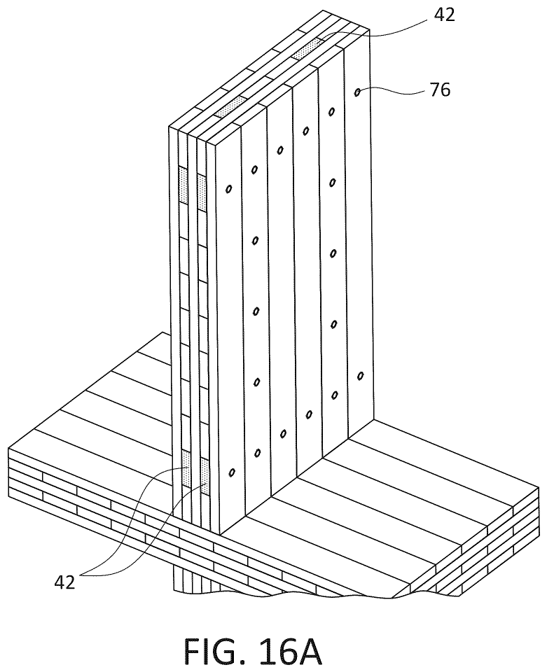

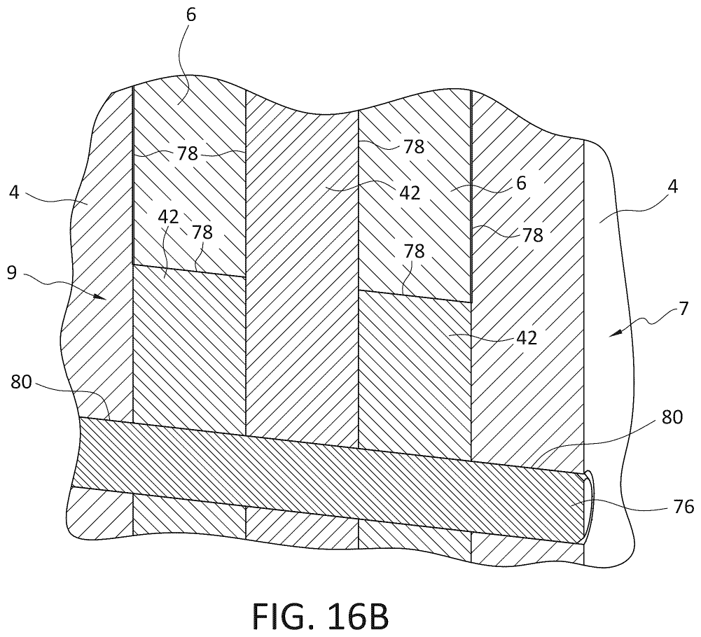

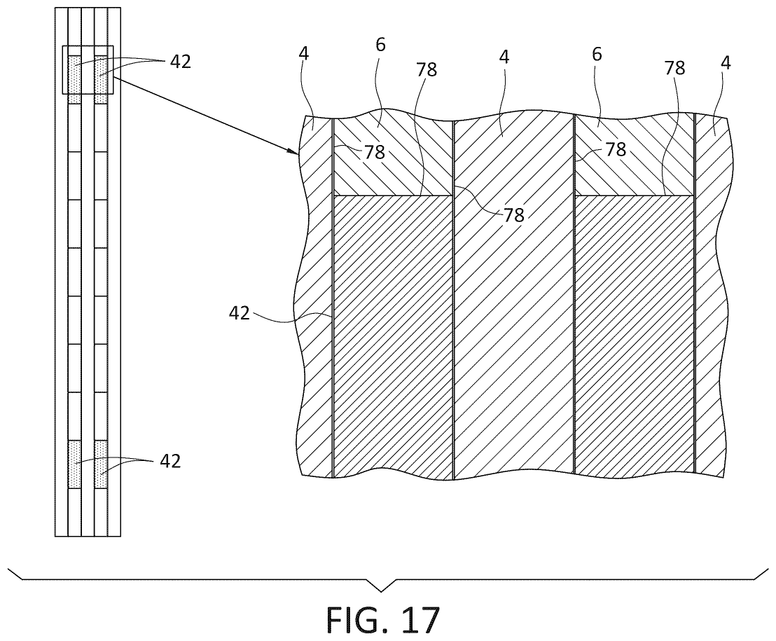

Referring to FIGS. 16A and 16B, the insert members made of engineered lumber 42 may be attached with wooden dowels 76 to each other and the neighboring lumber boards of the CLT panel. The dowels 76 extend from the outside layer 7 to the opposite outside layer 9 of the CLT panel. The dowels 76 are arranged horizontally along the horizontal insert members 42 and vertically along the vertical insert members 42. The dowels 42 may be glued and friction fit within the respective through holes 80 in the insert members 42 and lumber boards 4. The adjoining surfaces 78 are glued.

Referring to FIG. 17, the engineered lumber insert members 42 may be joined to the adjoining lumber boards 4 and 6 with glue between the adjoining surfaces 78.

The bolts 56, screws 68 and 74, the dowels 76 and the glue between adjoining surfaces of the insert members and lumber boards advantageously transfer the load imposed on the CLT panel to the insert members, which are stronger than the adjoining lumber boards of the CLT panel.

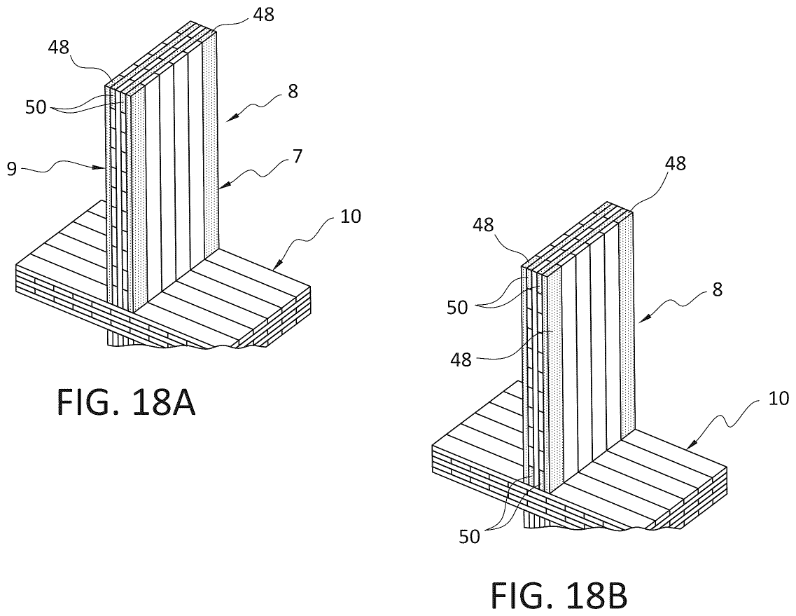

Referring to FIG. 18A, the insert members 48 may be positioned on the outside layers 7 and 9 and 50. The insert members 50 may also be positioned to the top edge or the bottom edge of the wall 8.

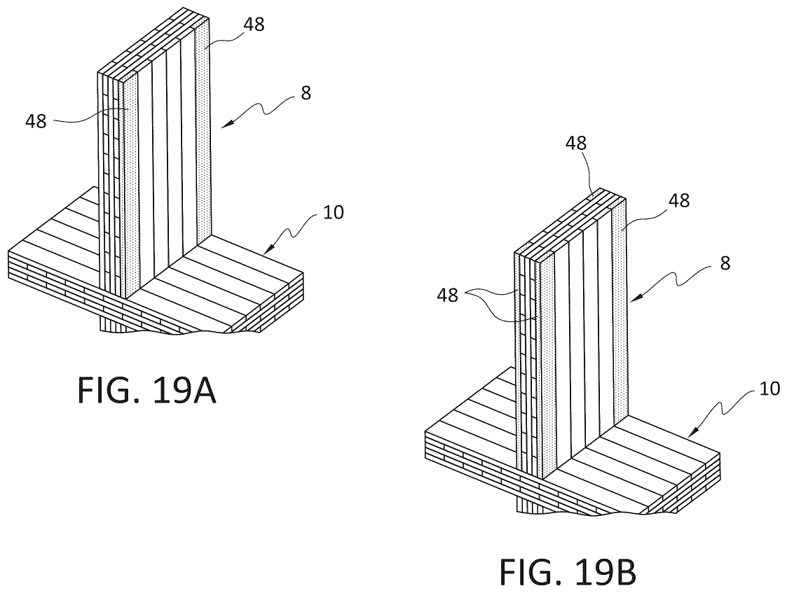

Referring to FIGS. 19A and 19B, the insert members 48 may installed on side only of the wall 8 or on both sides. The horizontal insert members 50 shown in FIGS. 18A and 18B may be also be dispensed with, depending on the application of the wall 8.

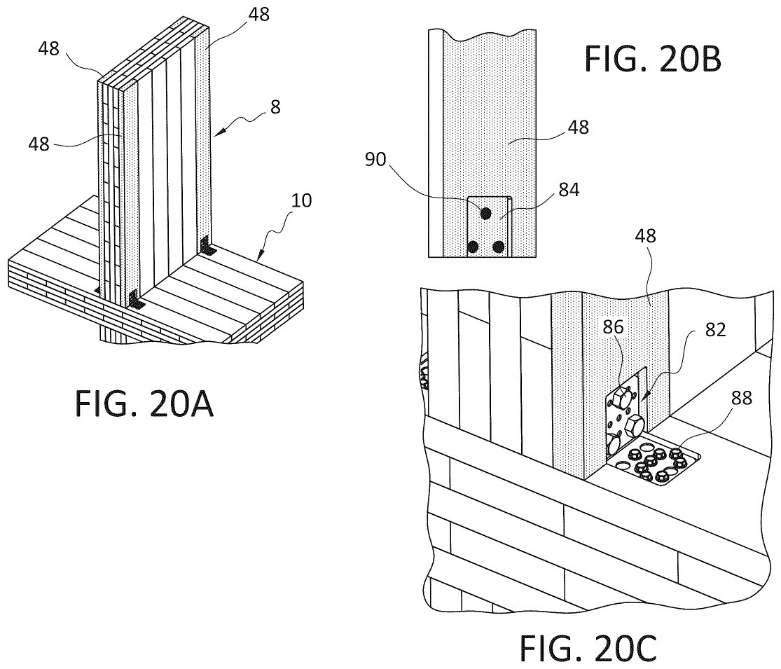

Referring to FIGS. 20A, 20B and 20B, the CLT wall 8 is provided with insert members 48 made of solid metal, disposed on the outside layers 7 and 9 of the CLT wall 8. Right angle brackets 82 are attached to the bottom end portions of the insert members 48 and to the CLT floor 10. Each of the brackets 82 is preferably set in recesses 84 in the respective insert member 48 and the floor 10 to advantageously keep the heads of the bolts 86 or screws 88 flush with the outside surfaces of the respective insert member 48 and the floor 10. Threaded holes 90 are provided in the insert members 48 to mate with the bolts 86.

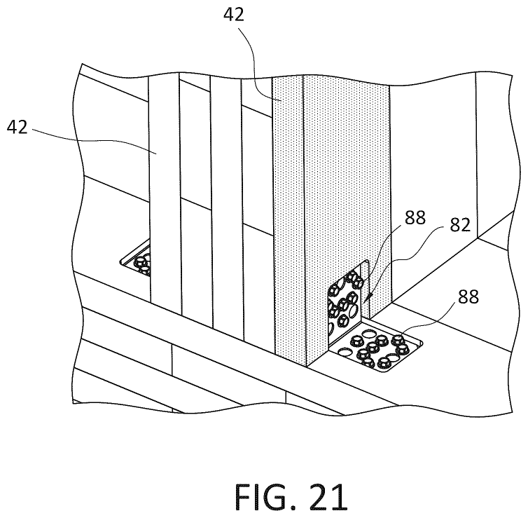

Referring to FIG. 21, the insert members 48 shown in FIG. 20A may be replaced with engineered lumber 42. The brackets 82 are attached with screws 88.

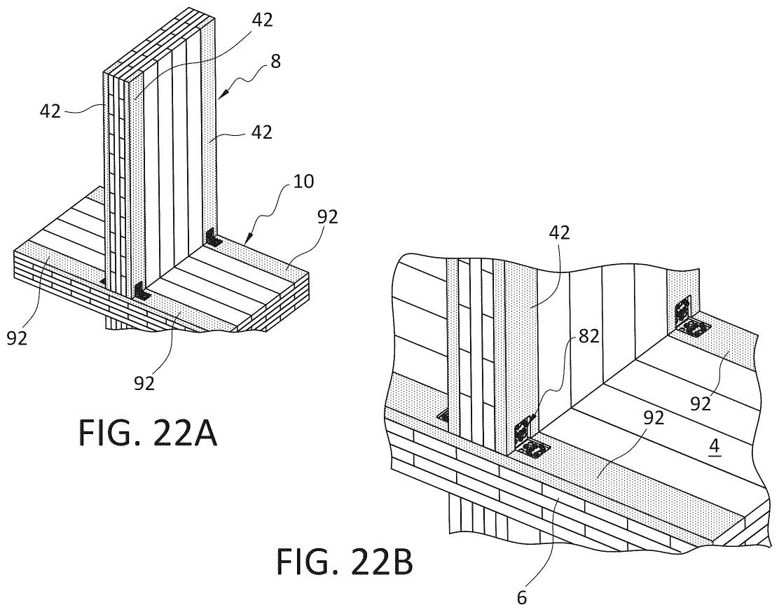

Referring to FIGS. 22A and 22B, engineered lumber 92 may also be provided in the CLT floor 10. The engineered lumber 92 advantageously spreads the compressive force of the wall 8 over a larger area on the softer lumber boards 4 and 6 than the actual footprint of the wall 8. Further, the insert members 42 and 92 advantageously provide higher compressive surfaces for the brackets 82 than that afforded by the standard lumber boards 4.

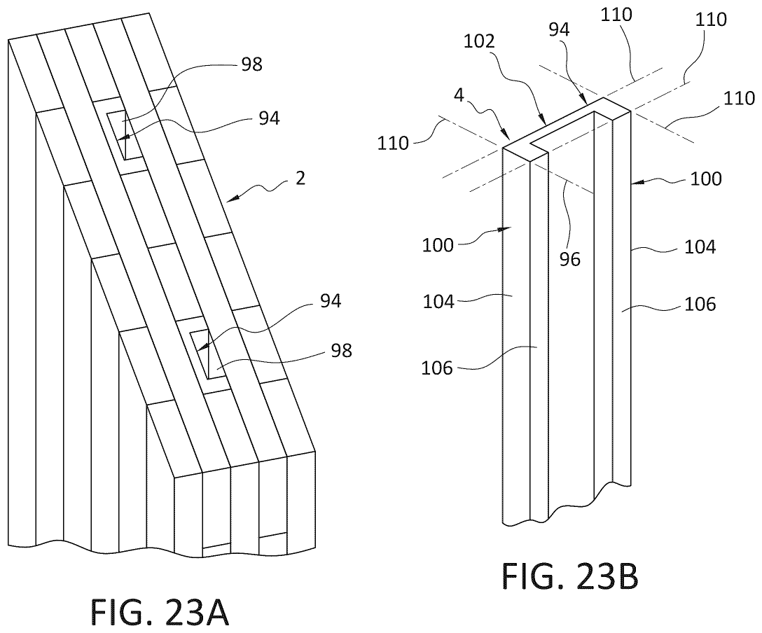

Referring to FIGS. 23A and 23B, one or more the lumber boards 4 and 6 have been modified as insert member 94. The insert member 94 includes a U-shaped trough 96 that provides a passageway 98 in the CLT panel 2. The trough 96 has sidewalls 100 and a base wall 102. The sidewalls 100 have respective outside surfaces 104 and 106 for gluing to the adjoining lumber boards. Similarly, the base wall 102 has outside surface 108 for gluing to the adjoining lumber board in the CLT panel 2. The passageway 98 may be used for routing cables, pipes, tie rods in the CLT panel 2 being used as a wall or floor. The side surfaces 106 advantageously provide gluing surfaces on all four sides or planes 110 of the insert member 94 for strength even with though part of the surfaces has been cut out to provide the trough 96.

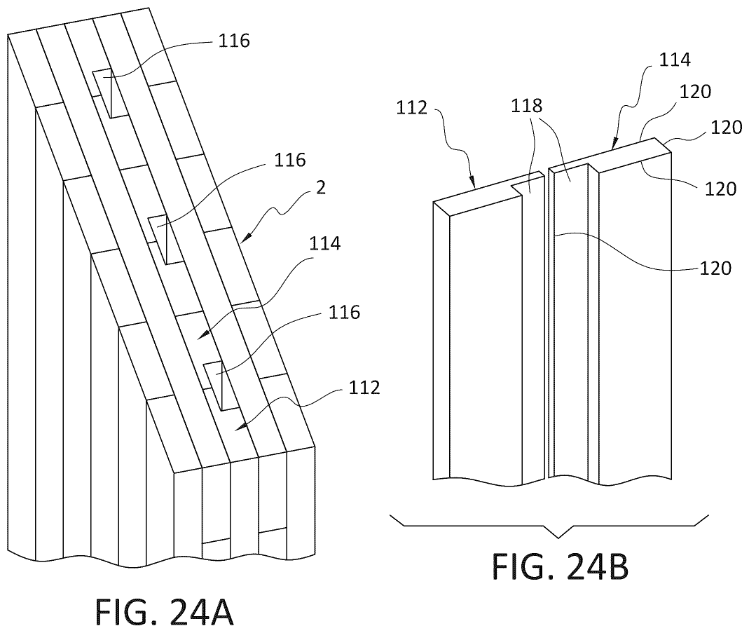

Referring to FIGS. 24A and 24B, two adjoining lumber boards have been modified as insert members 112 and 114 to provide a passageway 116 in the CLT panel 2. Each of the boards 112 and 114 includes complementary recesses 118 that are mirror images of one another. The recesses 118 are disposed along the longitudinal edges of the boards 112. As with the insert member 94, each of the insert members 112 and 114 have gluing surfaces 120 on all four sides or planes 110 of the insert members 112 and 114 for strength even though portions of the side surfaces have been removed to provide the recess 118. By making the passageway 116 with the two adjoining insert members 112 and 114, the amount of side surfaces available for gluing to the other adjoining lumber boards is increased as opposed to the insert member 94 with the cross-sectional area of the passageway 116 being the same as the that of the passageway 98.

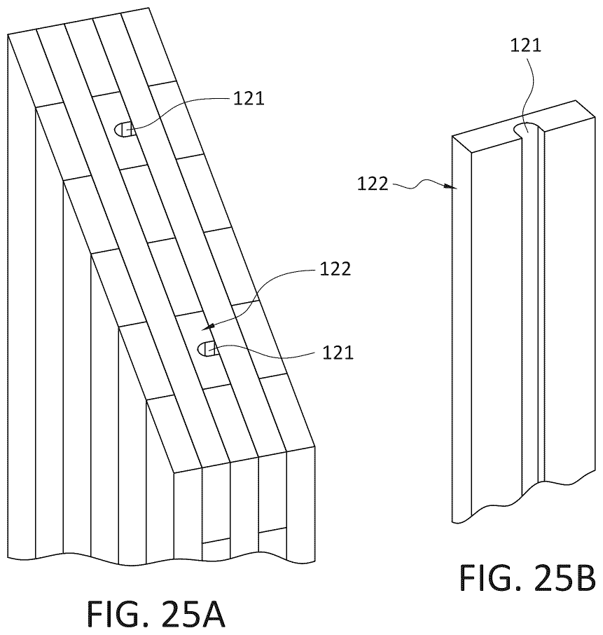

Referring to FIGS. 25A and 25B, the passageway 98 of FIG. 23A is modified into a half-oblong groove or passageway 121 in an insert member 122. The passageway 121 may be used for routing a tie rod, pipe, cable, etc.

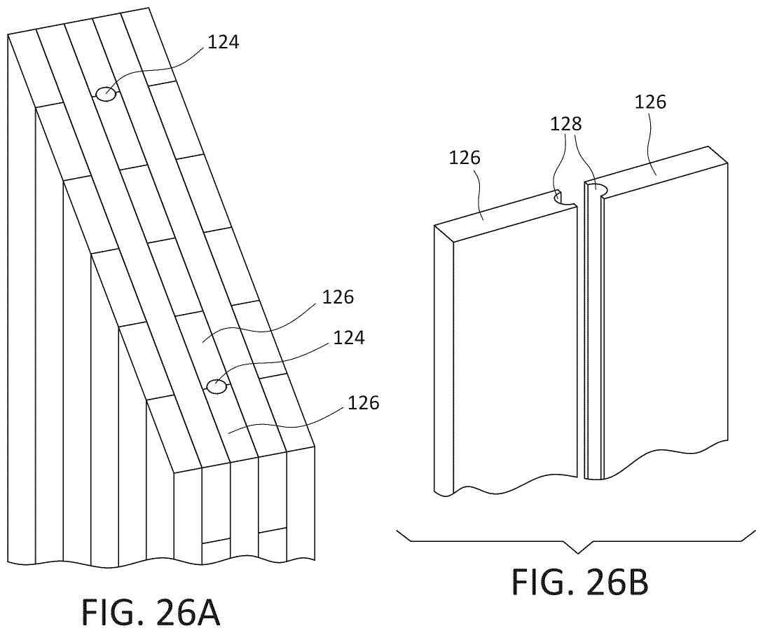

Referring to FIG. 26A and 26B, a circular passageway 124 is provided by two adjoining insert members 126, each of which is provided with a half-circular groove 128 along their longitudinal edges. As with the insert member 94, each of the insert members 126 has gluing surfaces on all four sides or planes 110 of the insert members 126 for strength even though portions of the side surfaces have been removed to provide the groove 128.

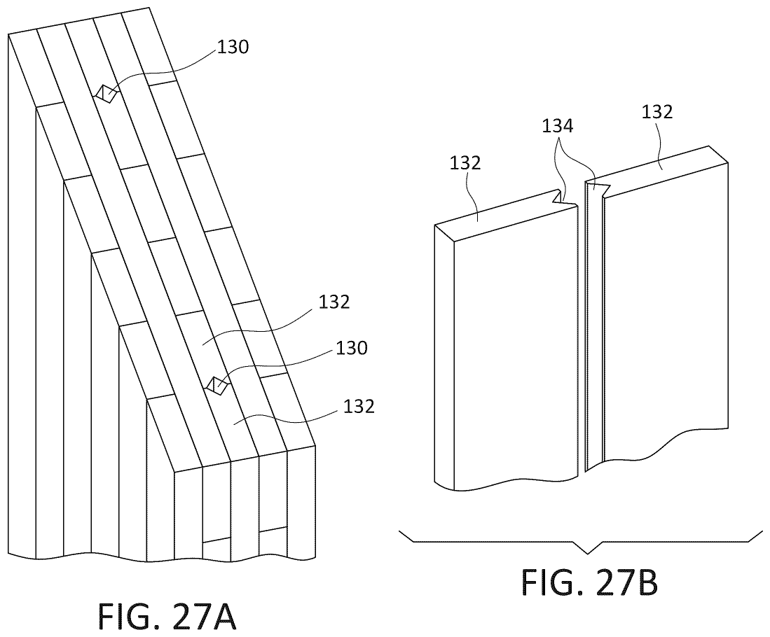

Referring to FIGS. 27A and 27B, the circular passageway 124 has been modified as a square passageway 130 in insert members 132. The adjoining insert members 132 are each provided with a V-shaped groove 134, which are mirror images of each other. As with the insert member 94, each of the insert members 132 has gluing surfaces on all four sides or planes 110 of the insert members 132 for strength even though portions of the side surfaces have been removed to provide the groove 134.

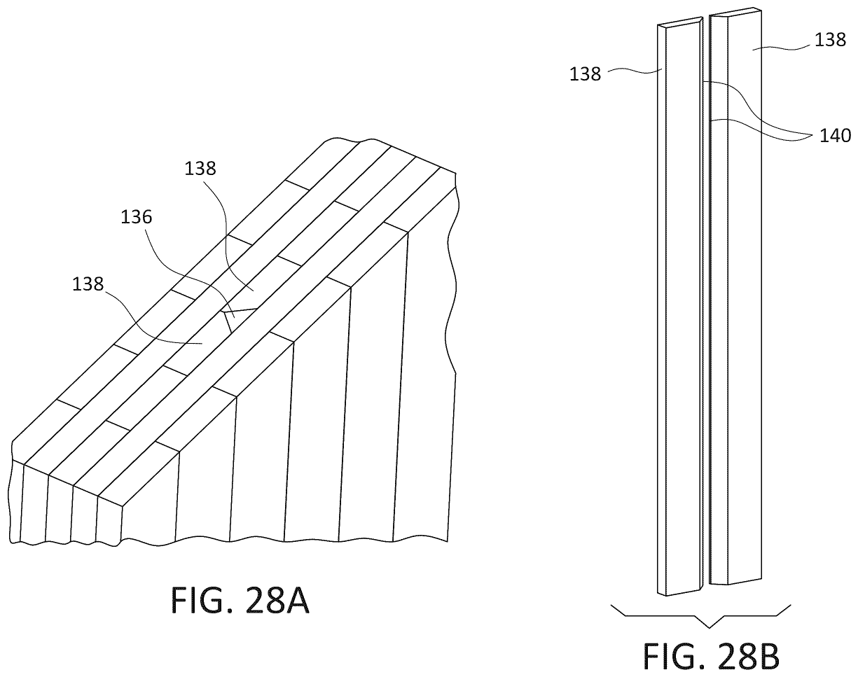

Referring to FIGS. 28A and 28B, the square passageway 130 has been modified as a triangular passageway 136 in insert members 138. The adjoining insert members 138 are each provided with a beveled surfaces 140, which are mirror images of each other. As with the insert member 94, each of the insert members 138 has gluing surfaces on all four sides or planes 110 of the insert members 138 for strength even though portions of the side surfaces have been removed to provide the beveled surface 140.

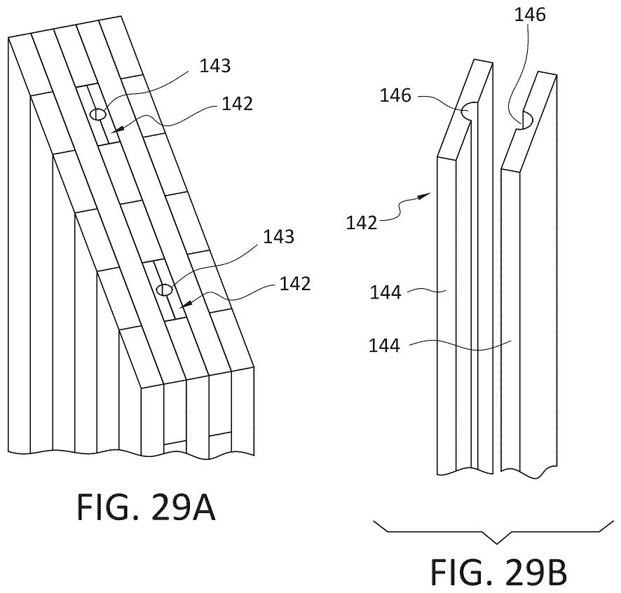

Referring to FIGS. 29A and 29B, insert members 142 are provided with circular passageways 143. The insert members 142 are made up of two half insert members 144, each of which is provided with half-circular grooves 146, which are mirror images of each other. The half insert members 144 are glued to each other and the adjoining lumber boards during the manufacture process. The half insert members 144 together make up one whole lumber board. The insert members 142 advantageously retain all their gluing sides along the planes 110 even with the provision of the circular passageway 143, which is interior of the insert member 142.

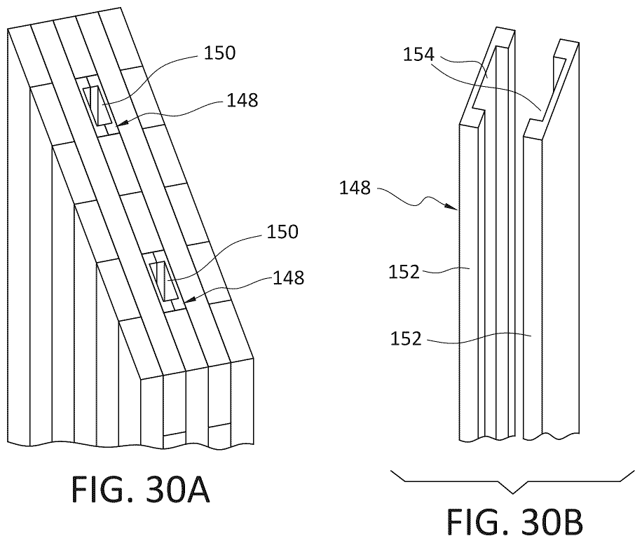

Referring to FIGS. 30A and 30B, insert members 148 are provided with rectangular passageways 150. The insert members 148 are made up of two half members 152, each of which is provided with rectangular grooves 154, which are mirror images of each other. The half members 152 are glued to each other and the adjoining lumber boards during the manufacture process. The half members 152 together make up one whole lumber board. The insert members 148 advantageously retain all their gluing sides along the planes 110 even with the provision of the passageway 150, which is interior of the insert member 148.

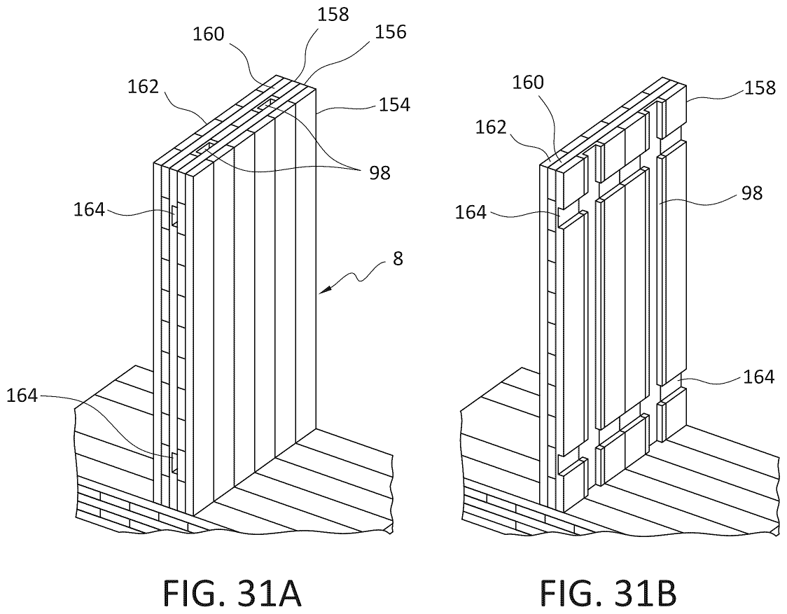

Referring to FIGS. 31A and 31B, the passageways disclosed in the CLT panels can run in two directions and intersect so that passageways running in one direction can communicate with other passageways running in the other direction. The CLT panel 8 is shown with five layers, namely, layers 154, 156, 158, 160 and 162. Passageways 98 in layer 158 are intersected by passageways 164 running transversely, preferably perpendicularly, to the passageways 98.

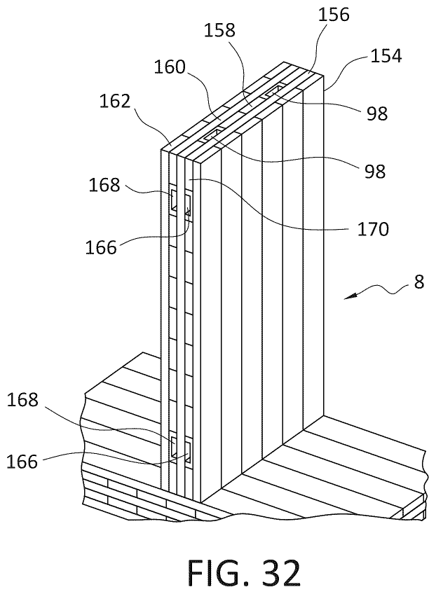

Referring to FIG. 32, the passageways 98 in layer 158 are intersected by passageways 166 in layer 156. Passageways 168 in layer 160 run transversely to the passageways 98, but are not in communication with the passageways 98. The passageways 166 and 168 are configured the same way as the passageways 98, as shown in FIGS. 23A and 23B. The passageways 98 and 166 share a common boundary 170 between the layers 156 and 158 so that where they intersect, the boundary 170 is open, allowing the passageways to connect.

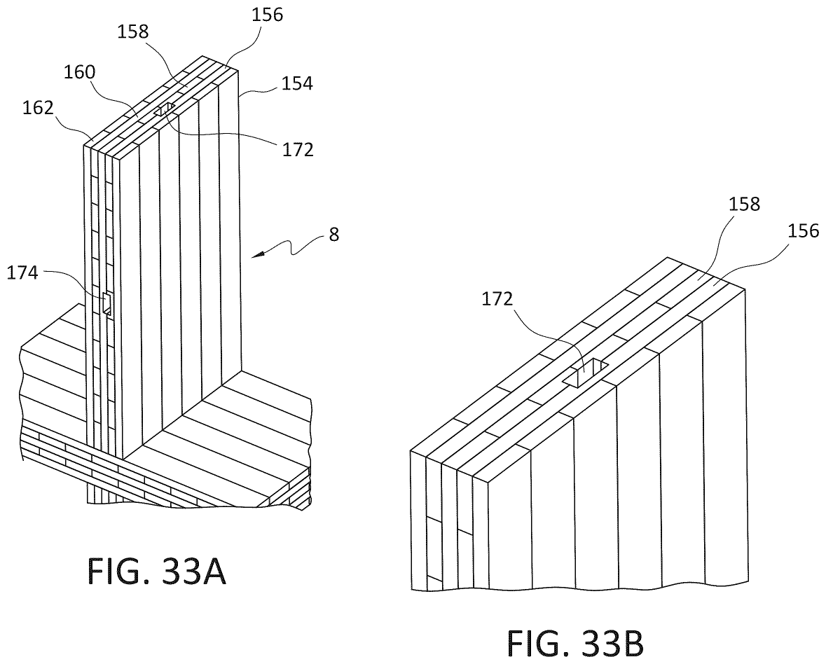

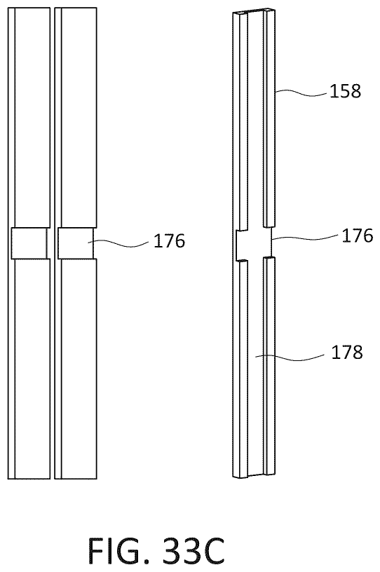

Referring to FIGS. 33A and 33B, passageways 172 and 174 are disposed in the layers 156 and 158. One half of the passageway 172 in the layer 158 may be configured according to the passageway 98 (FIGS. 23A and 23B) or 116 (FIGS. 24A and 24B). The other half of the passageway 172 is a groove running perpendicularly across the lumber boards in the layer 156. The passageway 174 runs perpendicularly to the passageway 172. The passageway 174 is open to the passageway 172 where they intersect. One half of the passageway 174 in the layer 156 may be configured according to the passageway 98 (FIGS. 23A and 23B) or 116 (FIGS. 24A and 24B) and the other half of the passageway is a groove 176 running perpendicularly across the members in the layer 158.

Referring to FIG. 33C, three members of the layer 158 are shown separated from their adjoining members. The groove 176 perpendicular to the members are shown intersecting with the groove 178 running parallel to the member. The groove 178 is shown as the groove 96 (FIG. 23B), but it should be understood that the groove 96 may also be configured according to the recesses 118 (FIG. 24B). The layer 156 is similarly illustrated where the groove 176 forms part of the passageway 172 and the groove 178 the passageway 174.

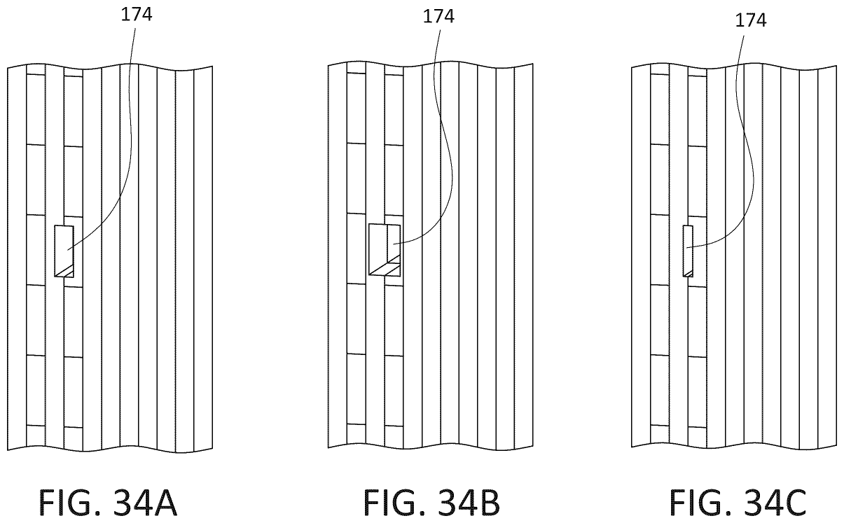

Referring to FIGS. 34A, 34B and 34C, the passageway 174 may be sized as wide as a member of the CLT panel (FIG. 34A), or wider than a member (FIG. 34B), or narrower than a member (FIG. 34C).

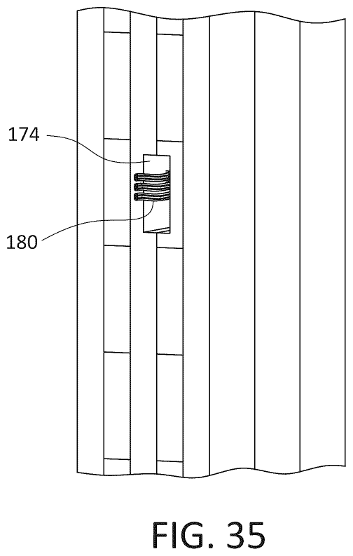

Referring to FIG. 35, cables 180 are routed through the passageway 174.

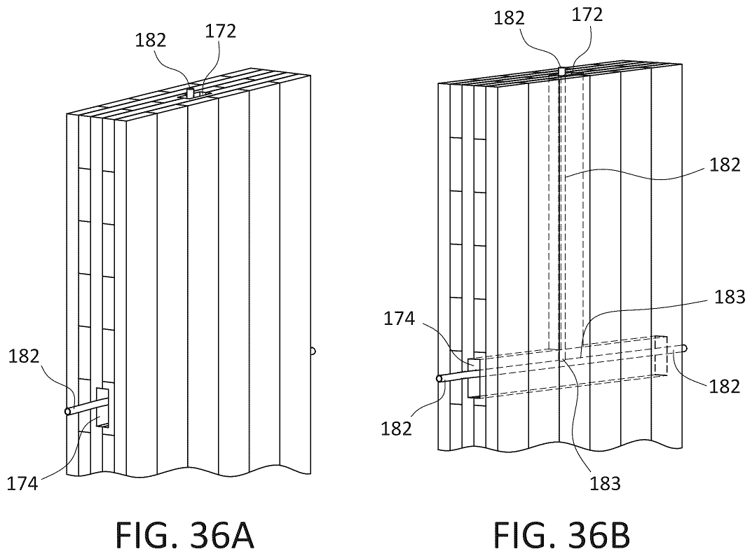

Referring to FIGS. 36A and 36B, a network of rigid pipes 182 is routed through the passageways 172 and 174. The pipes 182 would be installed in the passageways prior to gluing the members of the CLT panel together. A T-connection 183 is made at the intersection of the passageway 172 and the passageway 174.

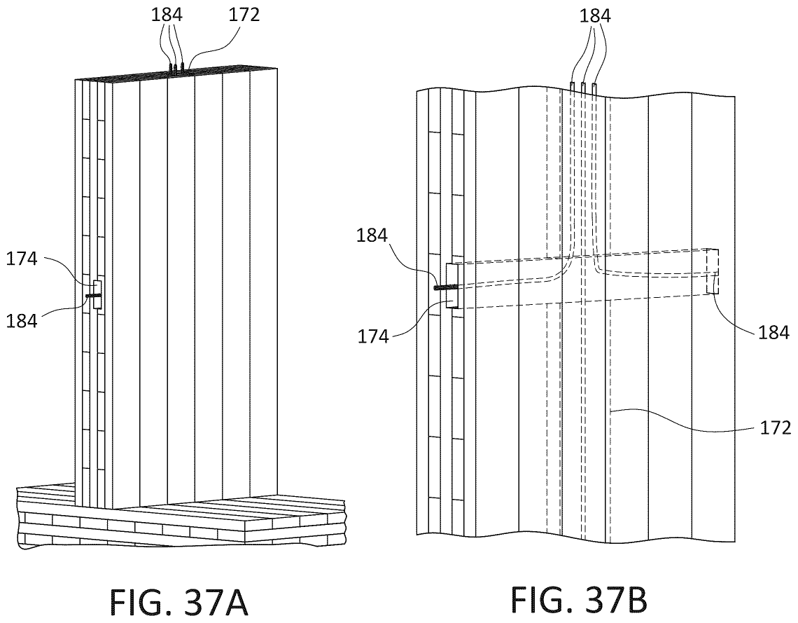

Referring to FIGS. 37A and 37B, flexible pipes 184 may be routed through the passageways 172 and 174. The pipe 184 changes direction at the intersection of the of the passageway 172 and the passageway 174.

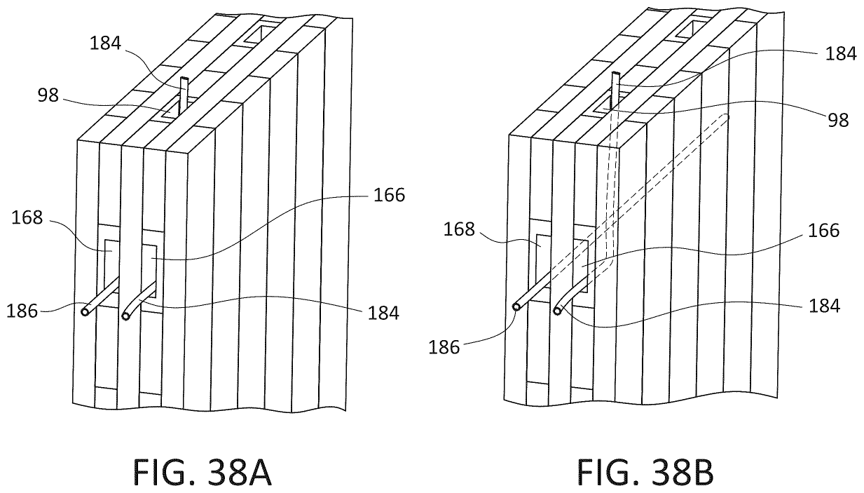

Referring to FIGS. 38A and 38B, the flexible pipe 184 is shown routed through the passageways 98 and 166. Flexible pipe 186 is routed straight through the passageway 186. The pipe 184 changes directions at the intersection of the of the passageway 98 and the passageway 166 where the passageway 98 opens into the passageway 166. The pipe 186 is routed straight through the passageway 168.

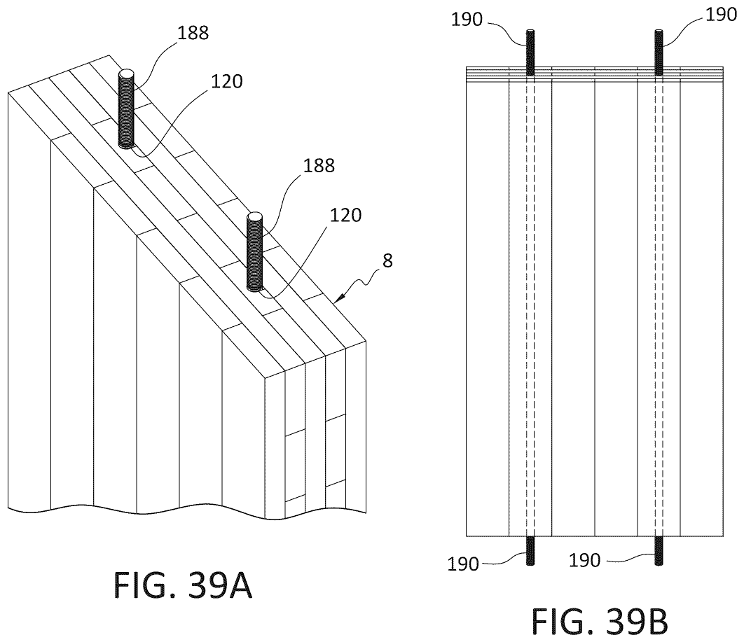

Referring to FIGS. 39A and 39B, tie rods 188 are routed through the passageways 121 (FIGS. 25A and 25B) through the length of the CLT wall 8. The tie rods 188 may be threaded only at the end portions 190 or threaded throughout. The tie rods 188 are used to anchor the CLT wall 8 to the foundation.

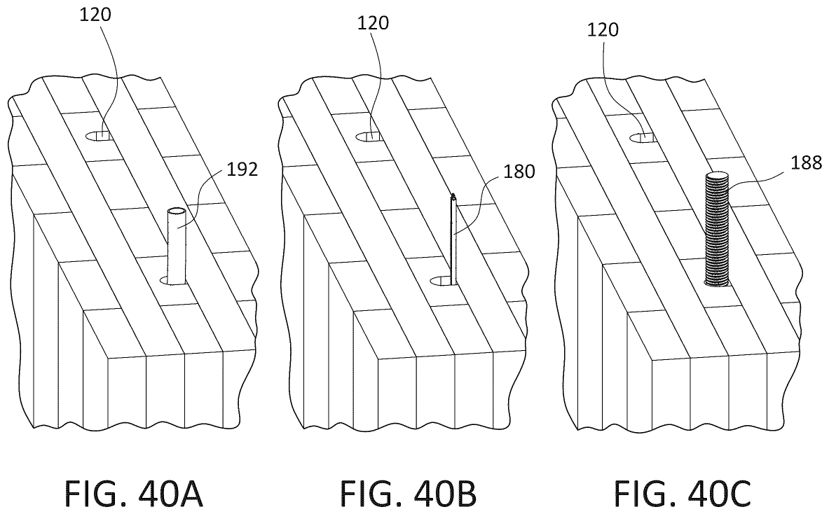

Referring to FIGS. 40A, 40B and 40C, the passageways 121 (FIGS. 25A and 25B) may be used to route a pipe 192, cable 180 or tie rod 188.

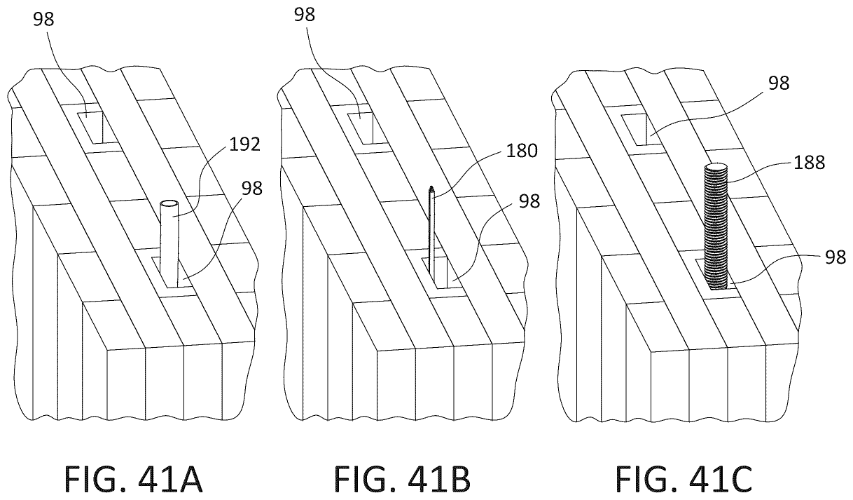

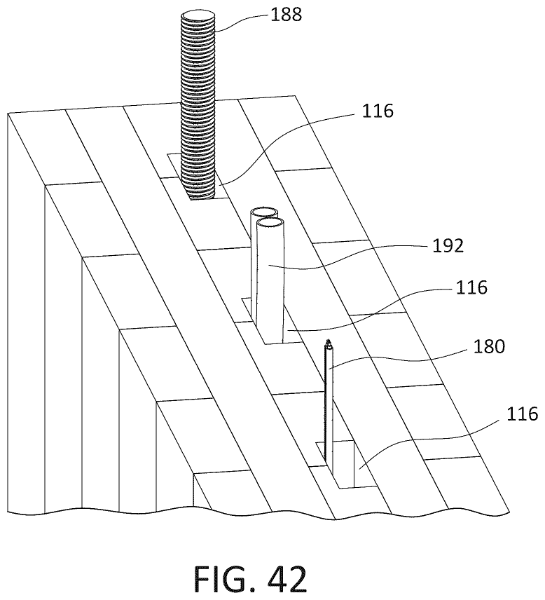

Referring to FIGS. 41A, 41B and 41C, the passageways 98 (FIGS. 23A and 23B) may be used to route a pipe 192, cable 180 or tie rod 188.

Referring to FIG. 42, the passageways 116 (FIGS. 24A and 24B) may be used to route a pipe 190, cable 180 or tie rod 188.

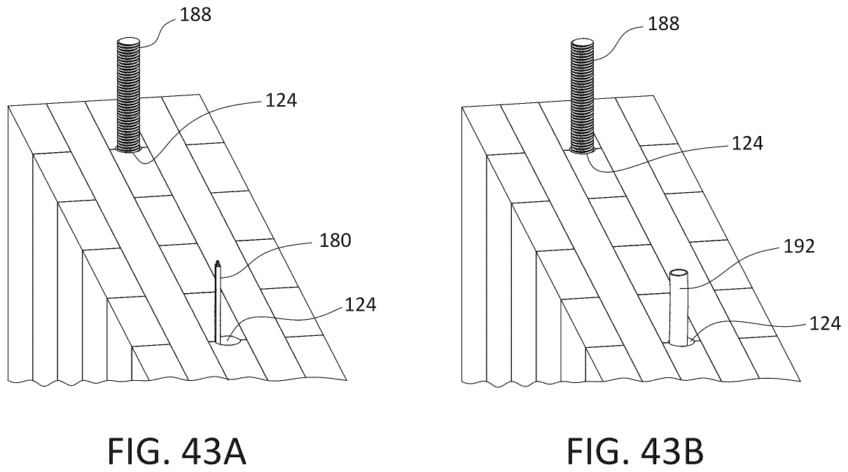

Referring to FIGS. 43A and 43B, the passageways 124 (FIGS. 26A and 26B) may be used to route a pipe 192, cable 180 or tie rod 188.

Referring to FIGS. 43A and 43B, the passageways 124 (FIGS. 26A and 26B) may be used to route a pipe 192, cable 180 or tie rod 188.

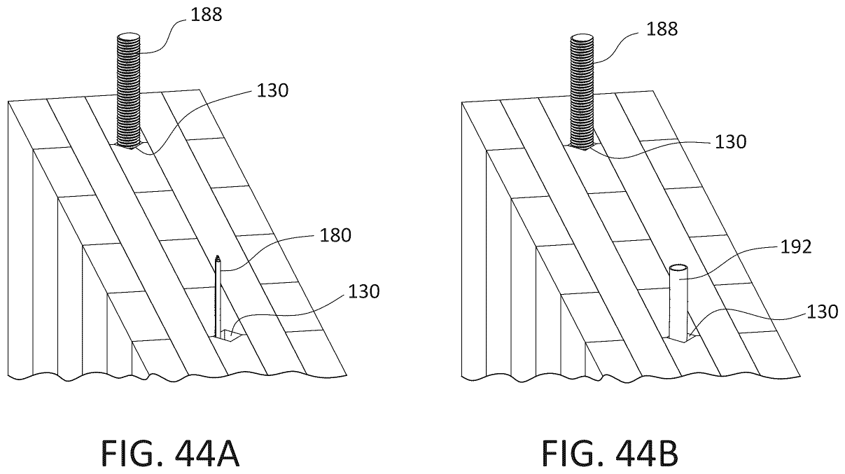

Referring to FIGS. 44A and 44B, the passageways 130 (FIGS. 27A and 27B) may be used to route a pipe 192, cable 180 or tie rod 188.

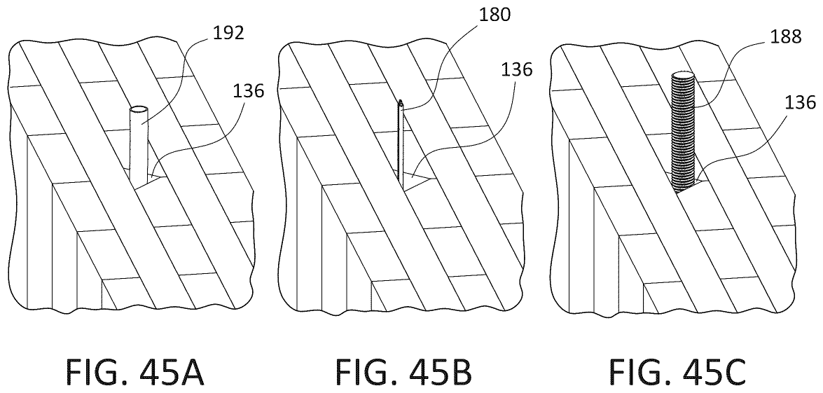

Referring to FIGS. 45A, 45B and 45C, the passageways 136 (FIGS. 28A and 28B) may be used to route a pipe 192, cable 180 or tie rod 188.

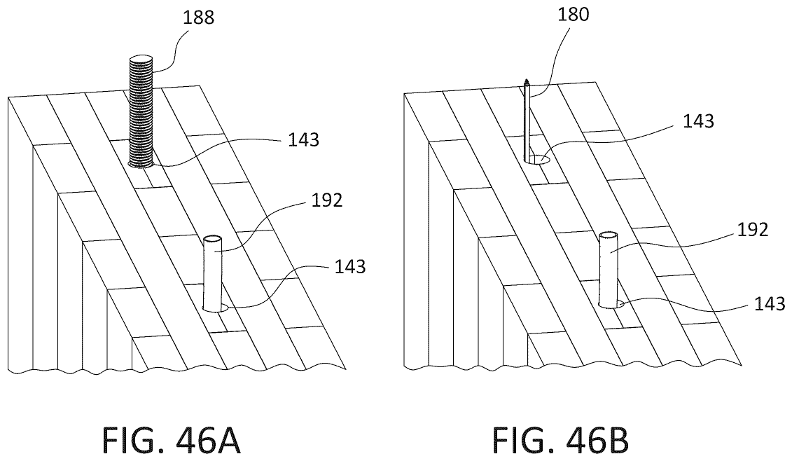

Referring to FIGS. 46 and 46B, the passageways 143 (FIGS. 29A and 29B) may be used to route a pipe 192, cable 180 or tie rod 188.

It should be understood that the various insert members described above, including the solid and hollow ones, may be used be used exclusively or in combination in a wall or floor panel, depending on the application. Although only one kind of insert members are shown in describing each embodiment, it should be understood that other types of insert members may also be combined in the same wall or floor panel.

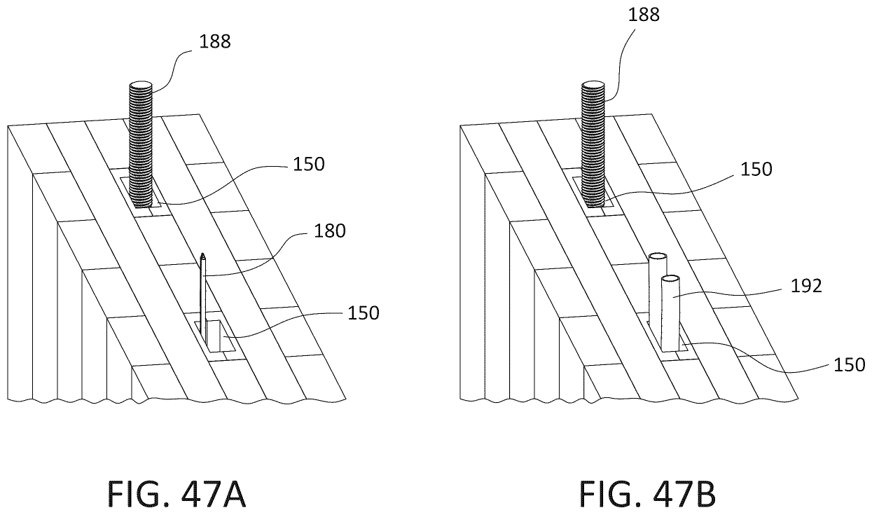

Referring to FIGS. 47A and 47B, the passageways 150 (FIGS. 30A and 30B) may be used to route a pipe 192, cable 180 or tie rod 188.

The various passageways described above may run all the way from the upper walls to the lower walls and down to the foundation, depending on the purpose. For example, the passageway that is used to run the tie rod 188 would extend to the foundation where the tie rod is anchored. Passageways for pipes, such as for water, may also run down to the foundation to connect to a main water supply.

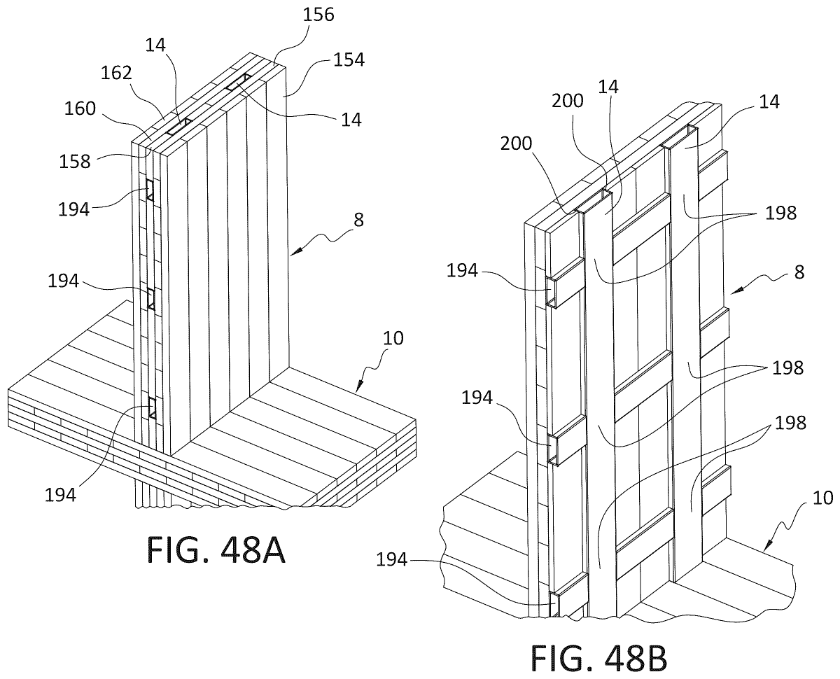

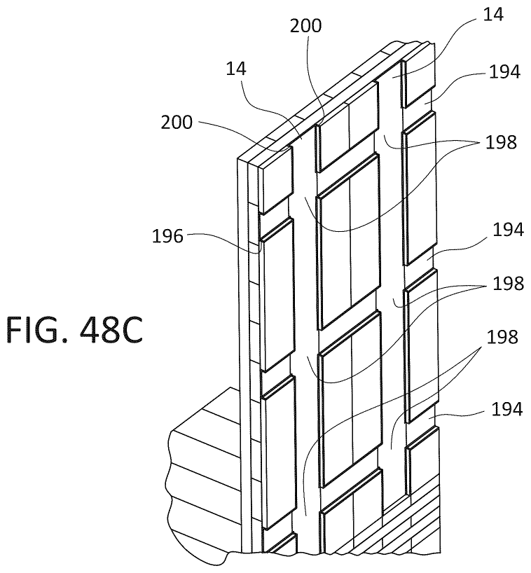

Referring to FIGS. 48A, 48B and 48C, rectangular tubes 14 and 194 are used to provide the various embodiments of passageways disclosed herein above. The tubes 14 and 194 are shown in the layer 158, but it should be understood that the tubes 14 and 194 may also be located in the other layers, such as the layer 156 or 160. The rectangular tubes 14 are disposed in locations where the lumber members 4 would ordinarily be found. Recesses 196 are provided in the layer 158 perpendicularly to the lumber members 4 and the tubes 14. At areas of intersections 198, the sidewalls 200 of the tubes 14 are open into the tubes 194 to provide communication between the interior volumes of the tubes 14 and 194.

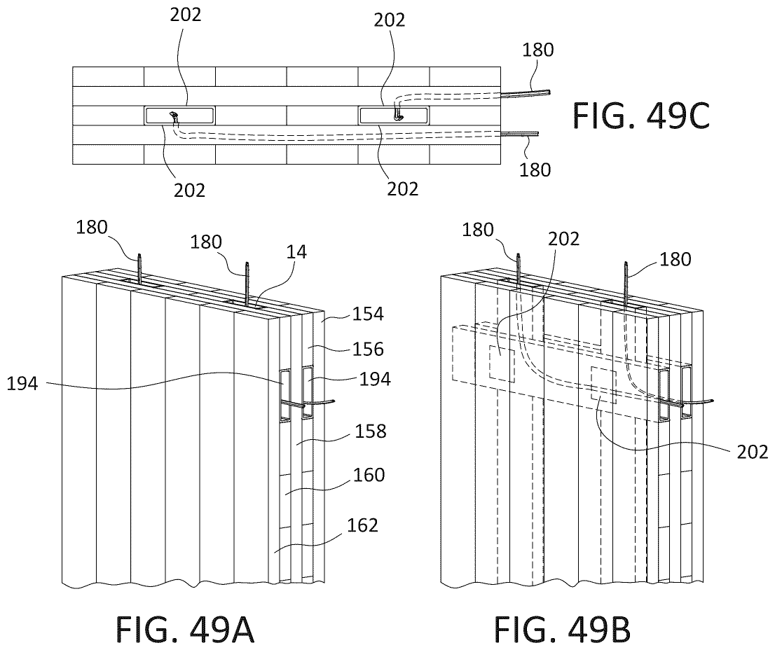

Referring to FIGS. 49A, 49B and 49C, the tubes 194 are disposed in a different layer from the tubes 14. The tubes 194 are disposed in the layer 156 and 160 and the tubes 14 in the layer 158. In the areas where the tubes 14 overlap with the tubes 194, openings 202 in the adjacent sidewall portions of the tubes 14 and 194 are provided so that the cable 180 in the tubes 14 can be routed to the tubes 194.

It should be understood that the tubes 14 and 194 may also take on the embodiments of the tubular members 22 or 28.

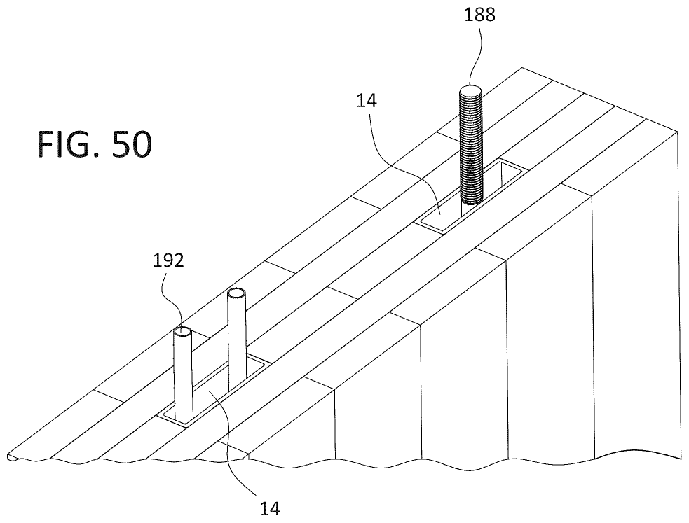

Referring to FIG. 50, the tubes 14 may be used to route pipes 192 and tie rods 188 through the CLT wall.

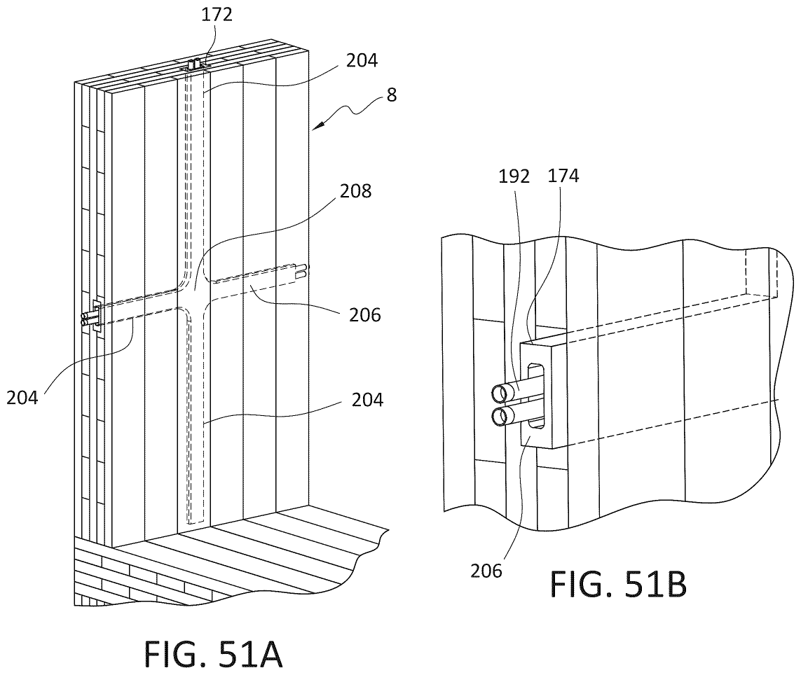

Referring to FIGS. 51A and 51B, the passageways 172 and 174 (FIGS. 33A and 33B) may be fitted with tubes 204 and 206 made of foam. Similar to the tubes 14 and 194, the interior volume of tubes 204 communicate with interior volume of tubes 206 at the intersection 208 of the tubes so that cables or flexible pipes can change direction at the intersection 208. The foam is preferably fire-retardant. Pipes 192 are shown installed in the tube 206.

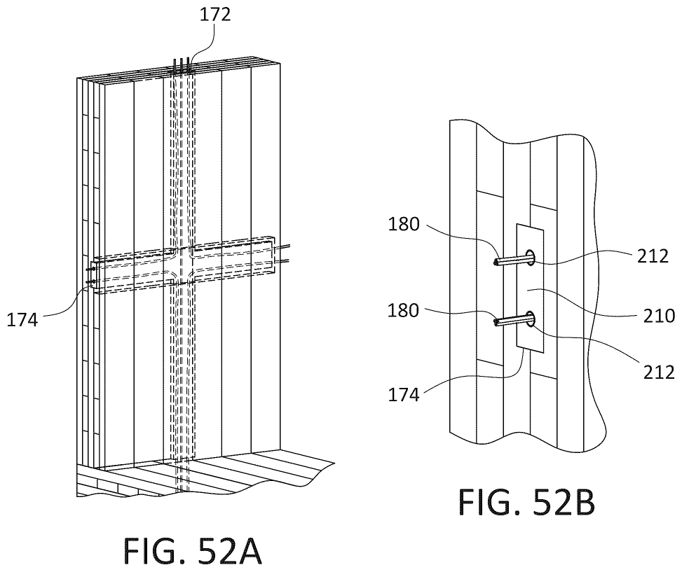

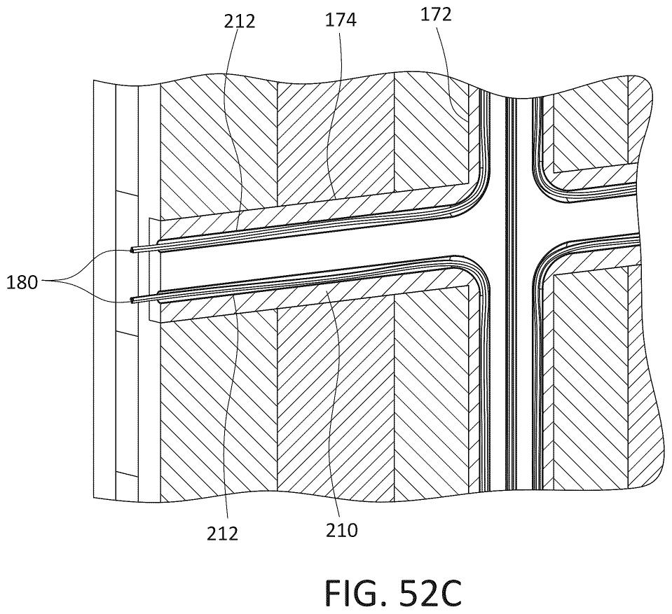

Referring to FIGS. 52A, 52B and 52C, the passageways 172 and 174 may be injected with expanding foam 210, preferably fire-retardant, after the conduits 210 are installed. The foam 210 advantageously fill the space within the passageways 172 and 174 and prevent fire and smoke from spreading. Cables 180 are routed through the conduits 212.

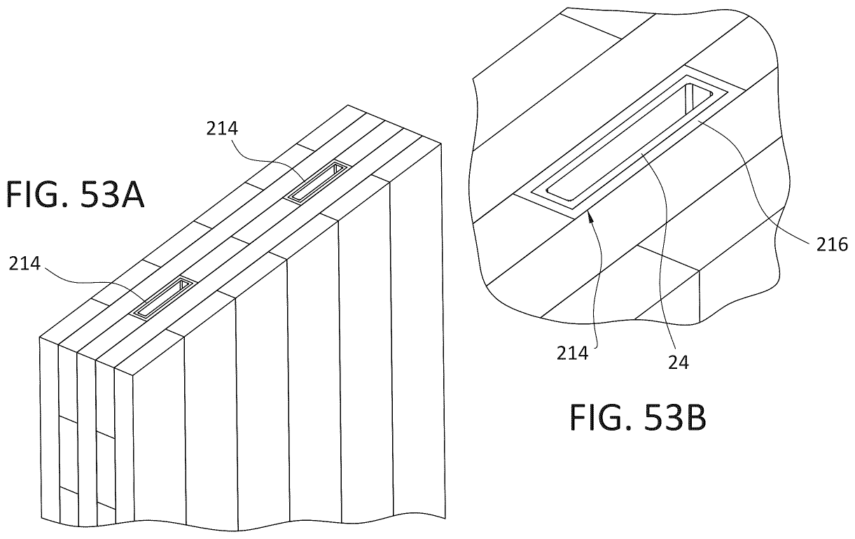

Referring to FIGS. 53A and 53B, the member 22 (FIG. 5) is modified as member 214 made of the rectangular tube 24 surrounded with foam 216. The encasing foam 216 advantageously compresses during the gluing and compression of the CLT panel during the manufacture process to absorb any imperfections in the space occupied by lumber member replaced by the member 214, thus avoiding causing damage to the tube 24, which may be made of plastic or metal, such as aluminum.

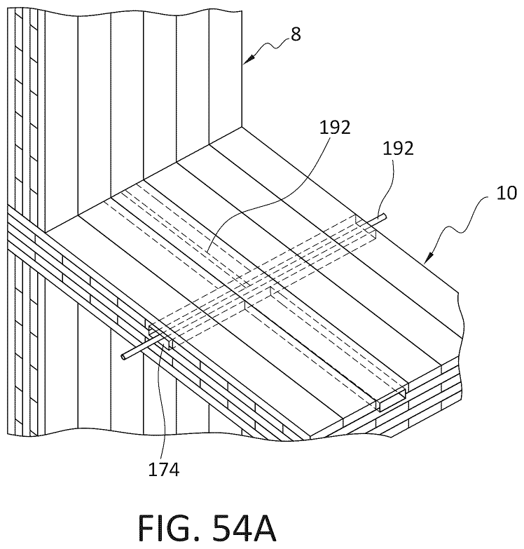

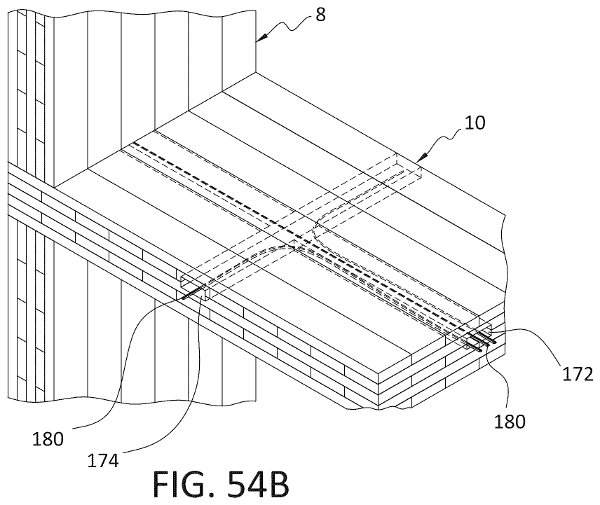

It should be understood that the afore-mentioned configurations for the wall 8 are equally applicable to the floor 10. For example, referring to FIGS. 54A and 54B, the passageways 172 and 174 are used to run cables 180 or pipes 192 in the floor. The passageways in the wall 8 may also connect and communicate with the passageways in the floor 8, advantageously allowing conduits, pipes, wires or other utilities to run from the wall to the floor or vice versa. Intersection of a passageway in the wall to a passageway in the floor, similar to an intersection between vertical and horizontal passageways as shown, for example, in FIG. 48B, advantageously provides a way for routing cables, pipes, conduits, etc. from the wall to the floor or vice versa.

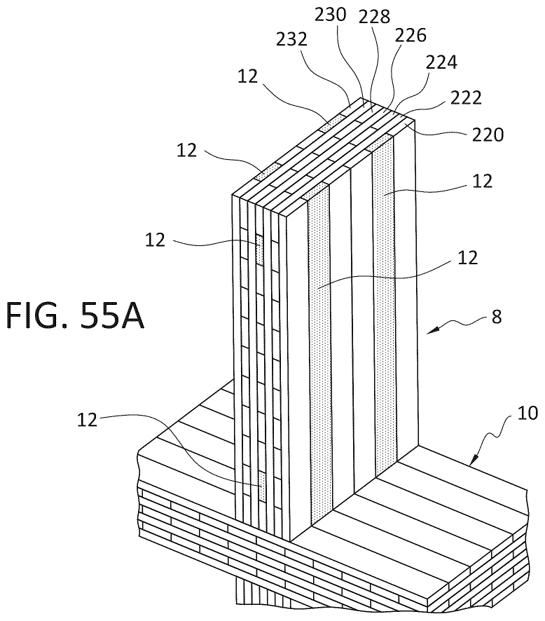

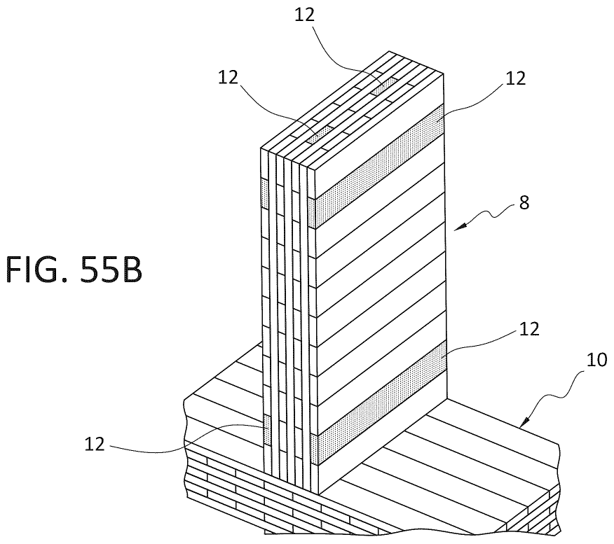

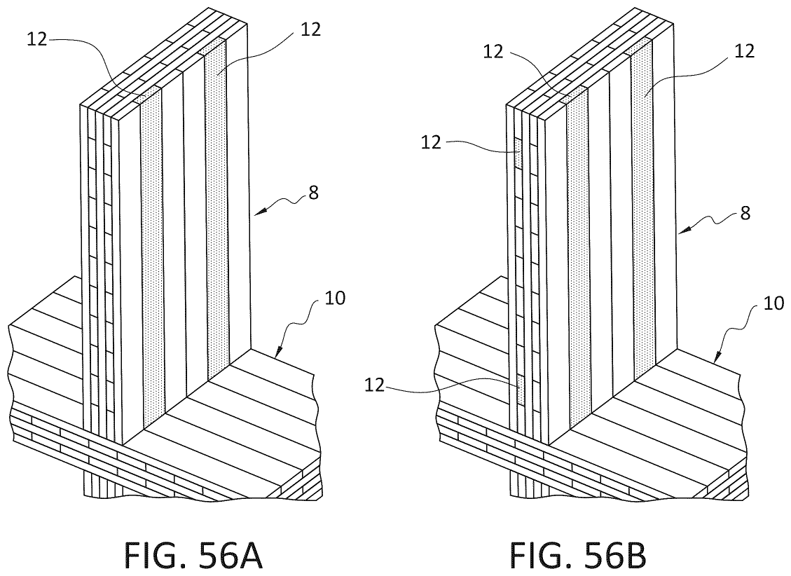

Referring to FIGS. 55A and 55B, a CLT wall 8 with 7 layers, namely, layers 220-232, with insert members 12 is disclosed. While the foregoing embodiments of the CLT panel show the insert members being disposed in adjoining layers, the insert members 12 are installed in non-adjoining layers 220, 226 and 232. The insert members 12 are installed symmetrically in the CLT wall 8. Insert members 12 are installed in the outer layers 220 and 232. Insert members 12 are also installed in an inner layer 224 in a transverse or perpendicular direction to the outer layer insert members 12. The configuration of the insert members 12 may also be used for the CLT floor panel 10.

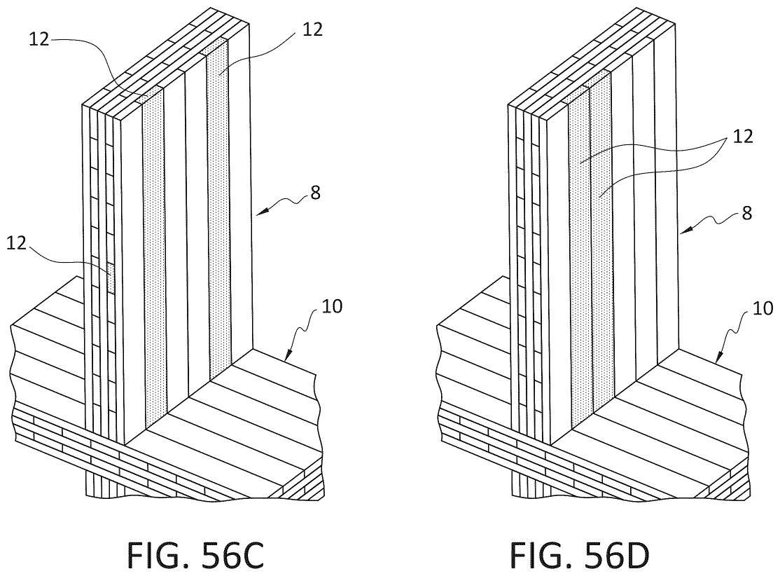

Referring to FIGS. 56A, 56B, 56C and 56D, the insert members 12 are installed asymmetrically in the CLT wall 8.

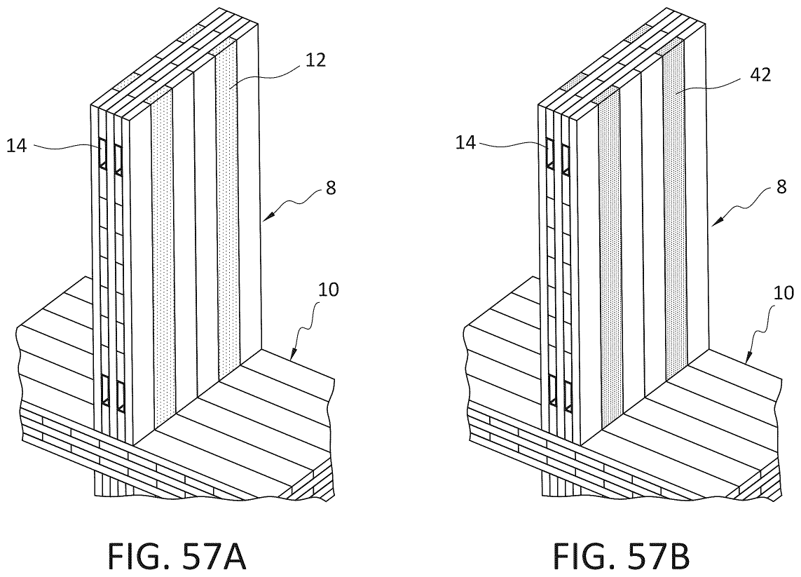

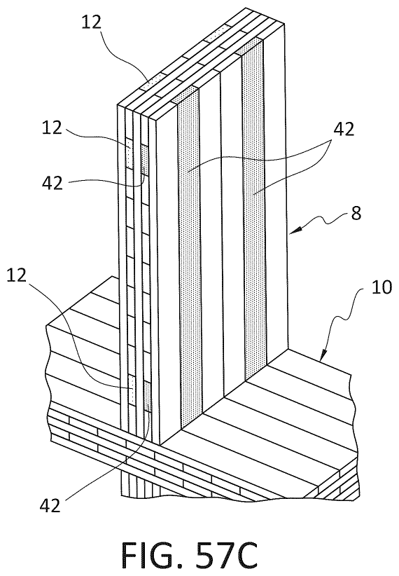

It should be understood that the various embodiments of the insert member 12 may be used in various combinations in the CLT panel in a wall or floor. For example, referring to FIGS. 57A, 57B, 57C and 57D, solid metal insert members 12 are used along with tubular insert members 14; engineered lumber insert members 42 in combination with tubular insert members 14; and solid metal insert members 12 with engineered lumber insert members 42. Other combinations of materials for the insert members for use in a CLT wall or floor panel are possible.

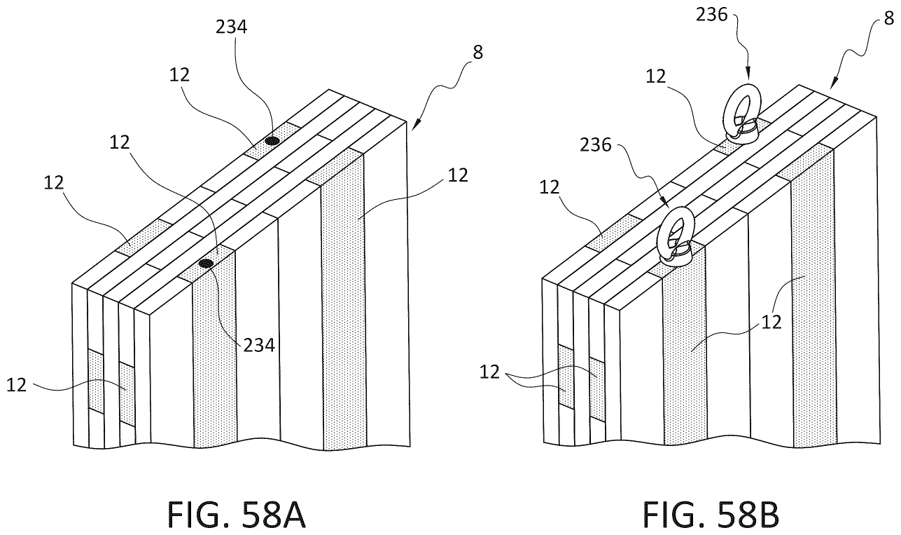

Referring to FIGS. 58A and 58B, the CLT panel 8 is provided with solid metal insert members 12, two of which are provided with threaded holes 234 for threadedly receiving respective standard lifting eye bolts 236. Attaching the lifting eye bolts 236 to the solid metal insert members 12 advantageously provide a relatively strong connection for lifting the CLT panel 8. The vertical insert members 12 are preferably attached to the horizontal insert members 12 to advantageously distribute the weight of the CLT panel 8 throughout.

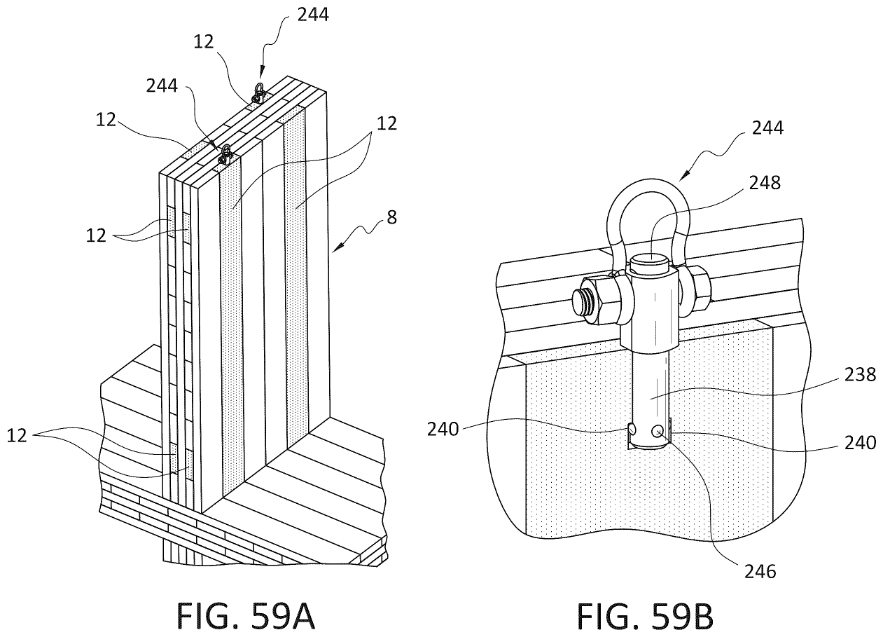

Referring to FIGS. 59A and 59B, two of the insert members 12 are provided with unthreaded holes 238 with respective enlarged bottom portions 240 to create respective shoulders 242. A standard lifting pin 244 includes retractable balls 246 that extend into the enlarge portion 240 to engage the shoulder 242 and resist separation from the insert member 12 during lifting of the CLT panel 8. A push-button 248 is effective to retract the balls 246 so the lifting pin can be removed. The hole 238 is parallel to the length of the insert member 12.

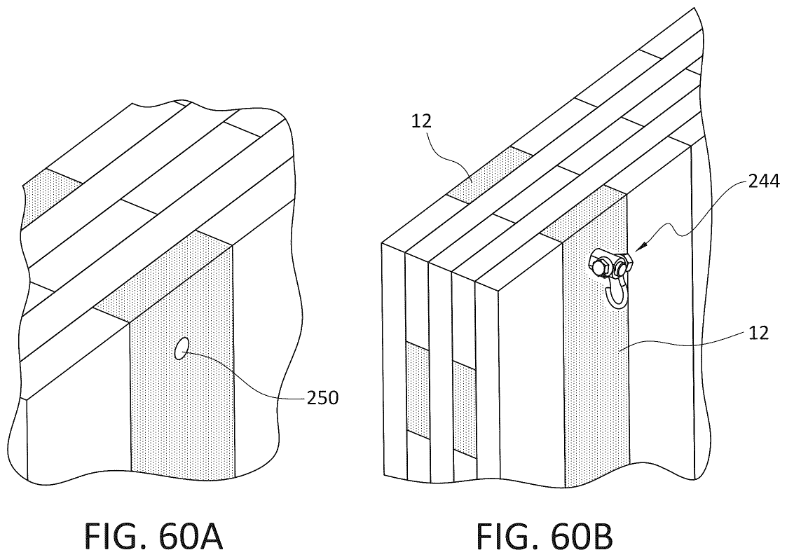

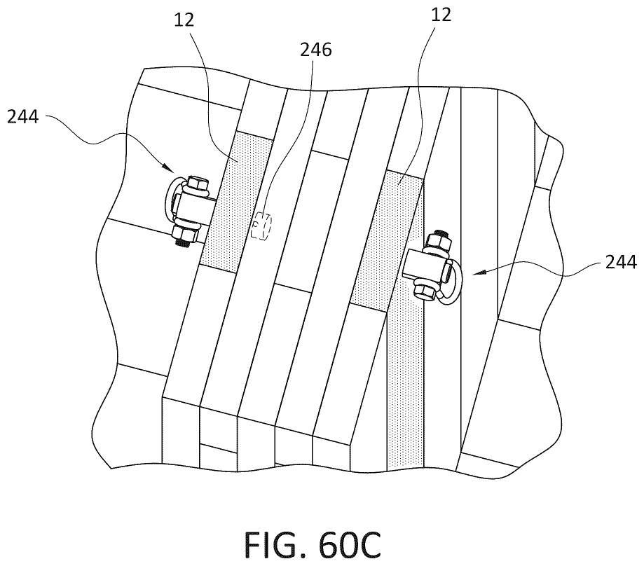

Referring to FIGS. 60A, 60B and 60C, the lifting pin 244 is attached to the side of the insert member 12. The lifting pin 244 extends through the thickness of the insert member 12 in a hole 250 so that the balls 246 extend and engage the other side of the insert member 12.

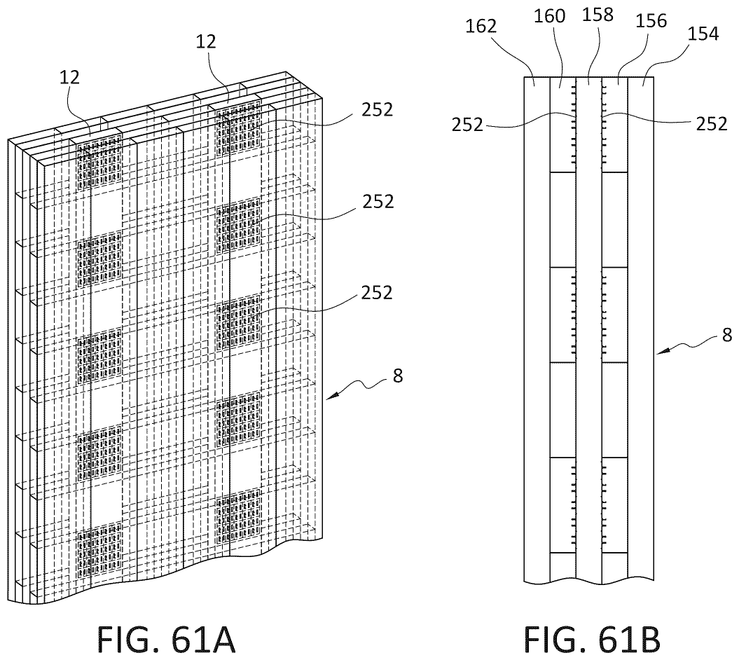

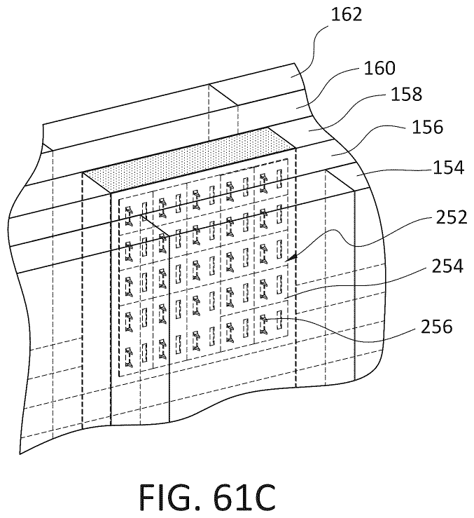

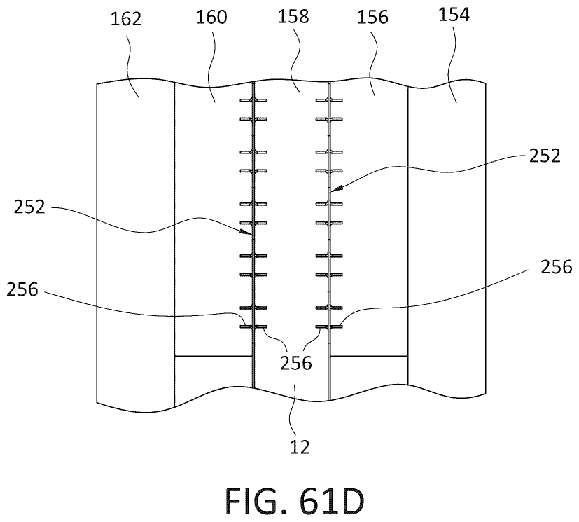

Referring to FIGS. 61A, 61B, 61C, 61D and 61E, insert members 12 made of wood or plastic are attached to adjoining layers 156 and 160 of the CLT panel with nail plates 252. A nail plate 252 comprises a metal base plate 254 with spikes 256 The spikes 256 are forced into the insert member 12 and the lumber boards in the adjoining layers 156 and 160, extending from both sides of the metal plate base 254. The nail plates 252 are preferably disposed on both of the wider sides or faces of the insert member 12. Each nail plate 252 is preferably square, covering substantially the width of the lumber board of the CLT panel 8. The nail plates 252 are preferably distributed along the length of the insert member 12 every other width of the lumber boards.

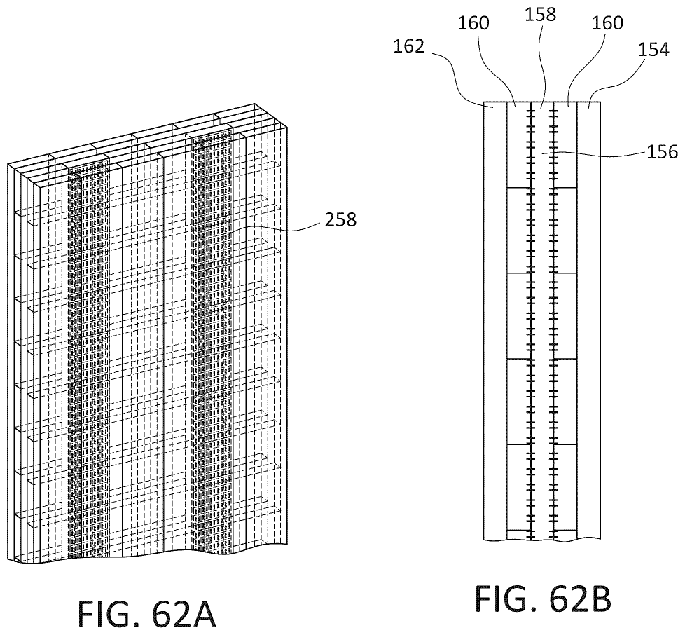

Referring to FIGS. 62A and 62B, the nail plates 252 are modified as nail plates 258 that extend the entire length of the insert member 12, thereby attaching insert 12 to all the lumber boards in the adjoining layers 156 and 160. The nail plates 258 are preferably substantially as wide as the width of the insert member 12.

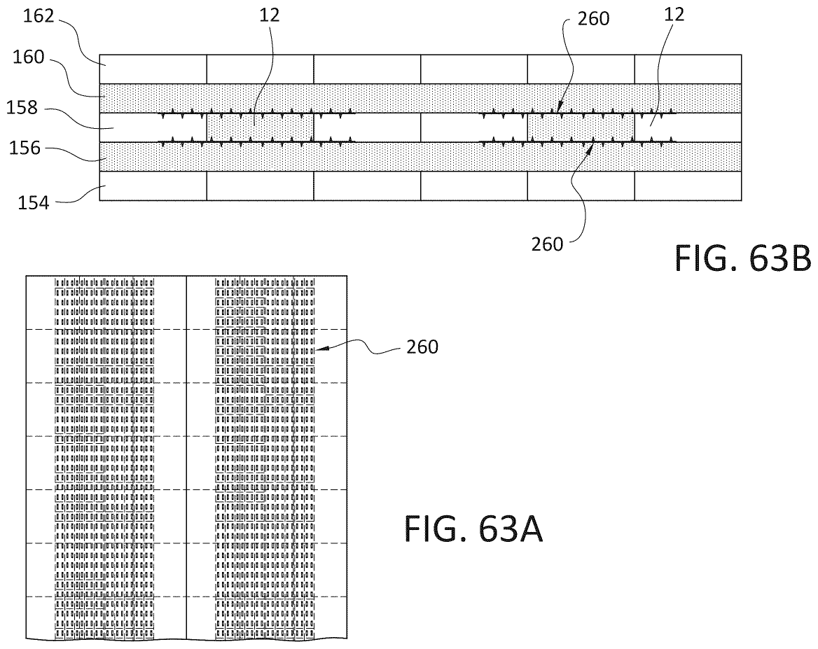

Referring to FIGS. 63A and 63B, the nail plates 258 are modified as nail plates 260 that are wider than the width of the insert member 12, thereby attaching the insert member 12 to the adjoining lumber boards in the same layer 158 as the insert member 12 and the lumber boards in the adjoining layers 156 and 160.

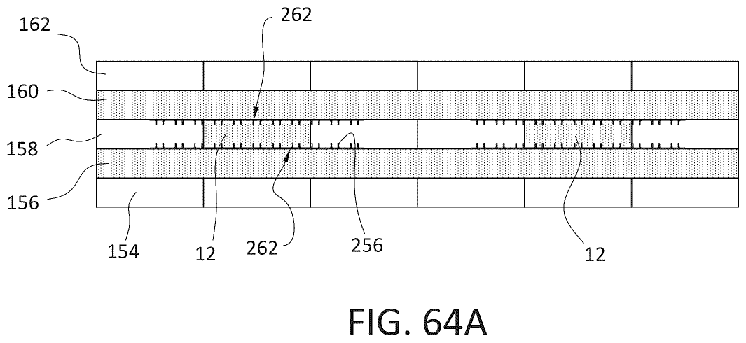

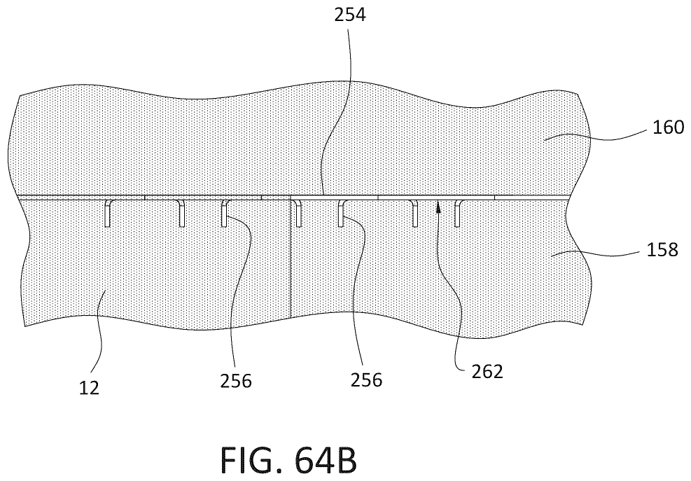

Referring to FIGS. 64A and 64b, the nails plates 260 are modified as nail plates 262 with the spikes 256 extending only from one side of the base plate 254. The nail plates 262 attach the insert members 262 to the adjoining lumber boards in the same layer 158 as the insert member.

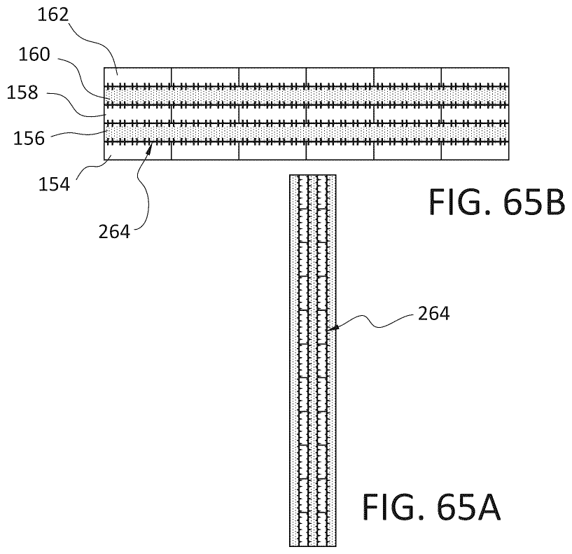

Referring to FIGS. 65A and 65B, the nail plates 260 are modified as nail plates 264 that extend the length and width of the CLT panel. The nail plates 264 attach the layers 154-162 to the respective adjoining layers and the lumber boards in each layer to the respective adjoining lumber boards.

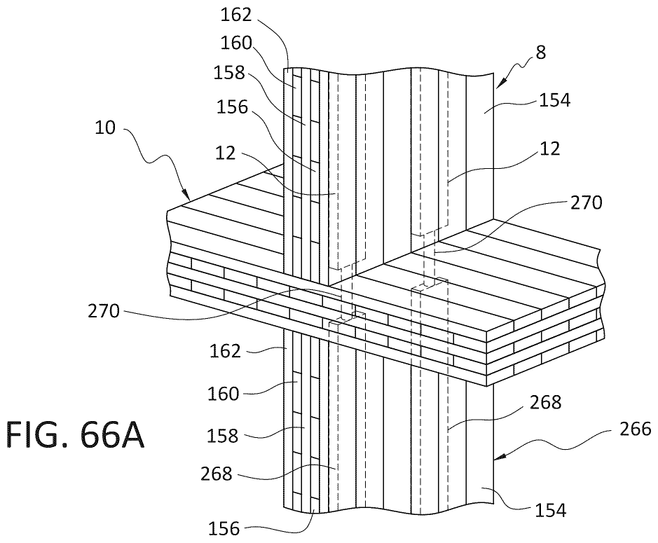

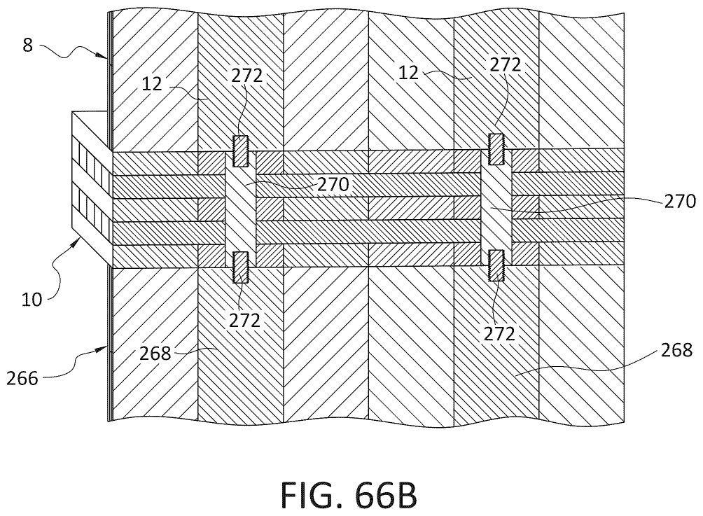

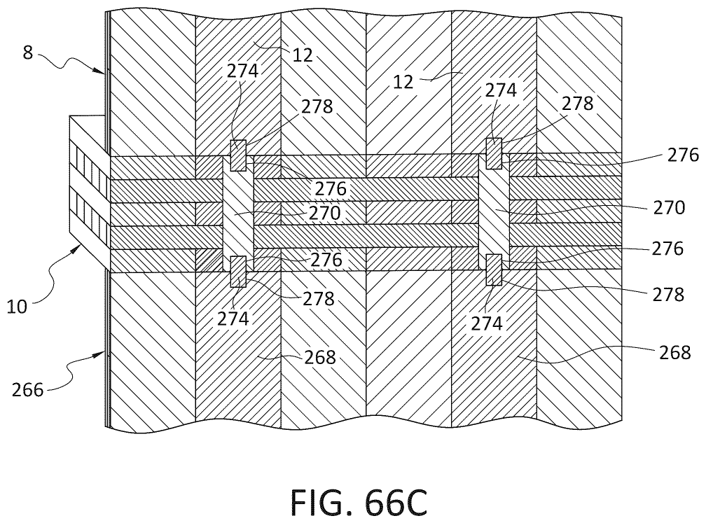

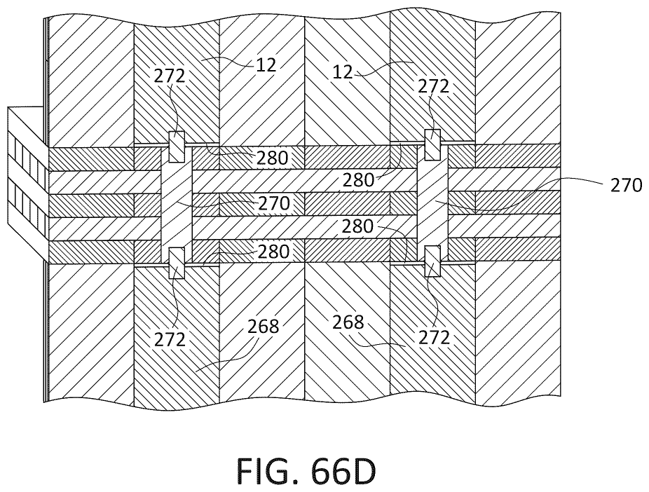

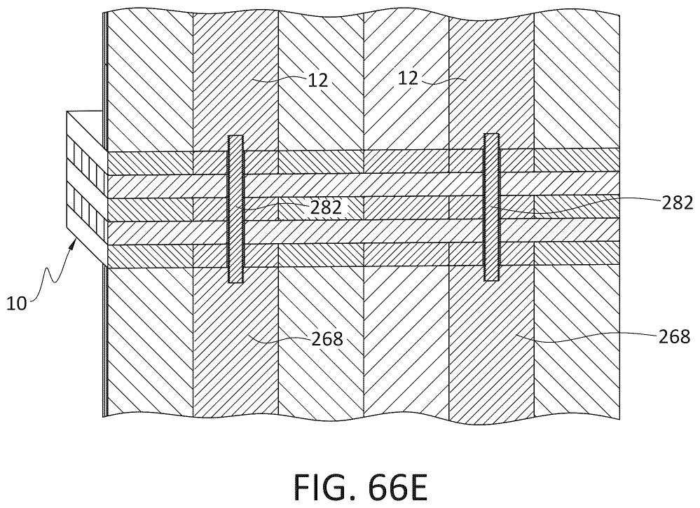

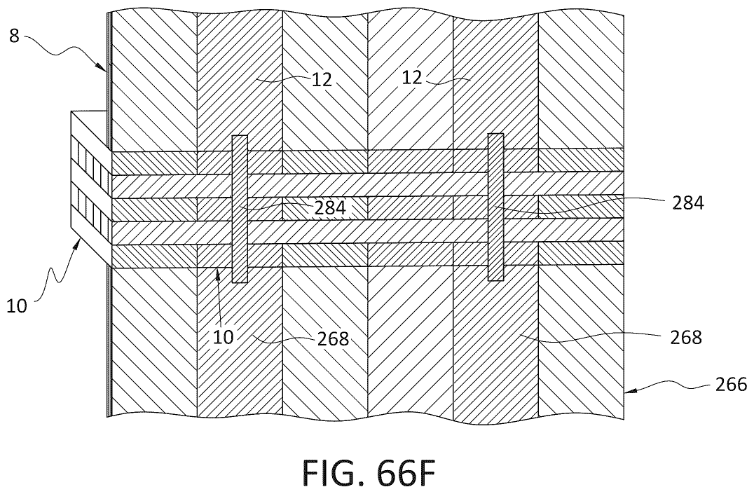

Referring to FIG. 66A, the CLT wall 8 is shown above the CLT floor 10. A CLT wall 266 below the CLT floor 10 is joined to the CLT wall 8 above. The CLT wall 8 includes the insert member 12 in an interior panel, such as layer 158. The CLT wall 266 also includes insert members 268 disposed in the same layer as the insert members 12, such as layer 158. The wall 8 is aligned with the wall 266. The insert members 12 and 268 are preferably made of hollow or solid metal designed to support the expected load on the walls 8 and 266.

Column insert member 270 preferably made of hollow or solid metal are disposed in and across the layers of the CLT floor 10 and are operably connected to the insert members 12 and 268 to advantageously transfer load from the wall 10 to the wall 266. The column insert member 270 is preferably perpendicular to the horizontal plane of the floor 10 and extends through the thickness of the floor 10. The column insert member 270 is preferably circular in cross-section but other shapes such as square, rectangular, hexagonal, etc. may also be used.

Referring to FIG. 66B, the column insert members 270 are operably attached to the insert members 12 and 268 with threaded studs 272 threadedly connected to the column insert members 270 and the insert members 12 and 268. Through the use of insert members 12 and 268 and the column insert member 270, the load on the floor 10 is reduced. Since lumber has lower load capacity when loaded perpendicular to the grain than when loaded parallel to the grain, the load on the floor 10 whose grain is perpendicular to the load of the wall 8 is advantageously reduced via transfer of some of the vertical load through the insert members 12 and 268 and the column insert members 270.

Referring to FIG. 66C, non-threaded pins 274 operably connect the column insert members 270 to the insert members 12 and 268. The pins 274 preferably engage the bottoms and sides of the holes 276 and 278 to advantageously provide load transfer for both downward and lateral forces.

Referring to FIG. 66D, gaps 280 may be provided between the insert members 12 and 268 and the respective top and bottom surfaces of the floor 10 so that load is transferred directly from the insert members 12 to the column insert members 270 to the insert members 268 via the threaded studs 272 or the non-threaded pins 278 (shown in FIG. 66C).

Referring to FIGS. 66E and 66F, threaded studs 282 or non-threaded pins 284 extend across the CLT floor 10, operably transferring load from the insert members 12 above the floor to the insert members 268 below. The studs 282 or pins 284 may be in the form of cylindrical members.

It should be understood that the column inserts 270 provide the same function as the studs 282 or the pins 284 in reducing loading on the floor 10 by transferring some load from the upper wall 8 directly to the lower wall 266.

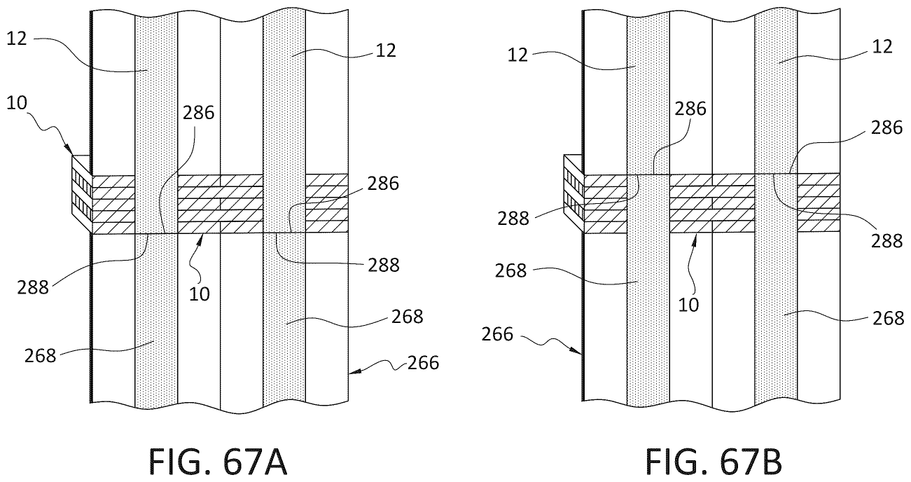

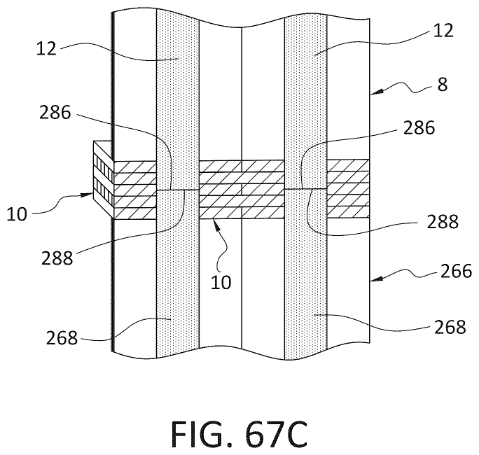

Referring to FIGS. 67A, 67B and 67C, the insert members 12 have bottom ends 286 that extend through the thickness of the floor 10 and engage the top ends 288 of the insert members 268. Alternatively, the insert members 268 have top ends 288 that extend through the thickness of the floor 10 and engage the bottom ends of the insert members 12. Still alternatively, the insert members 12 have bottom ends 286 that extend partway or midway into the thickness of the floor 10 and engage the top ends 288 of the insert members 268 that also extend partway or midway into the thickness of the floor 10. These configurations advantageously transfer some of the load from the wall 8 to the lower wall 266, advantageously reducing the load on the floor 10.

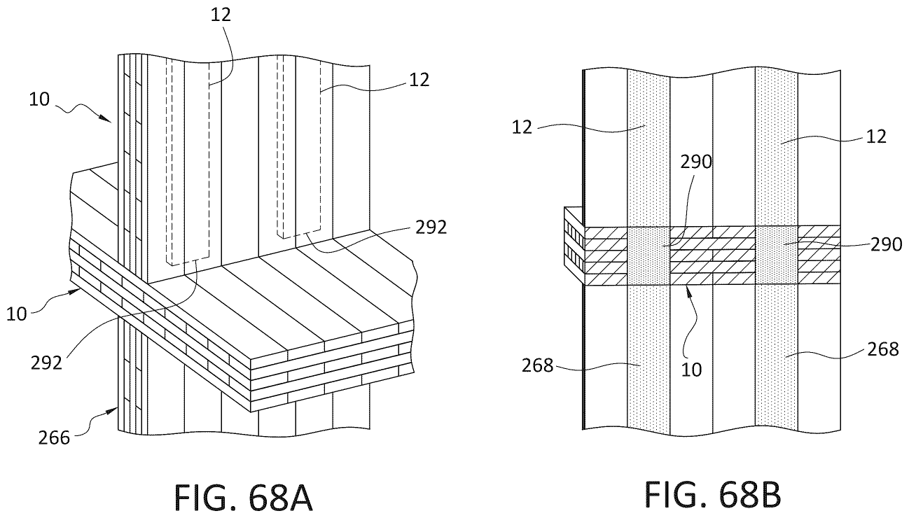

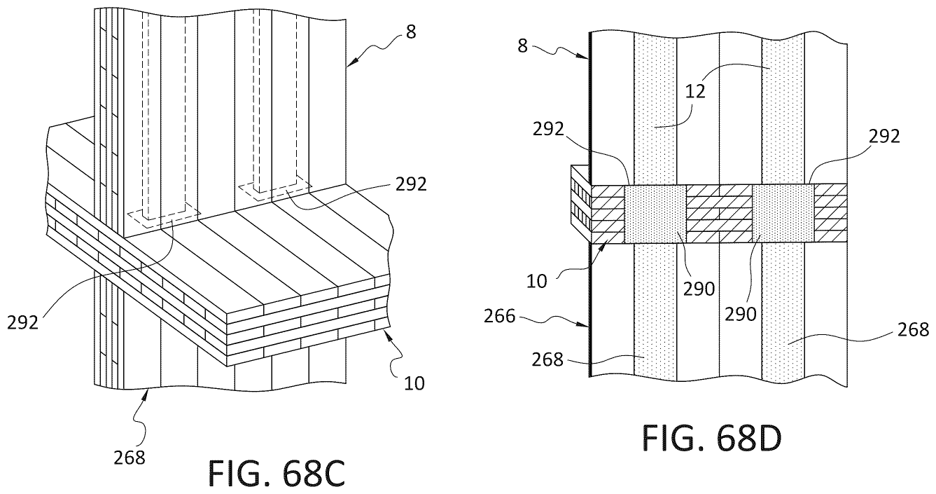

Referring to FIGS. 68A, 68B. 68C and 68D, members 290 are inserted inside and across the thickness of the floor 10 to bridge the insert members 12 and 268 across the floor 10. The ends of the members 290 are aligned with the ends of the respective ends of the insert members 12 and 268. The members 290 preferably have properties that are the same as or stronger than the insert members 12 and 268. The members 290, for example, may be made of metal or wood having the same or greater compressive strength as the inserts 12 and 268. For the members 290 made of wood, the members may be oriented, for example having the fibers parallel to the load, to provide maximum strength. The members 290 have cross-sectional areas or bearing areas 292 equal to or greater than the bearings areas or cross-sectional areas of the bottom end or the top end of the insert members 12 and 268.

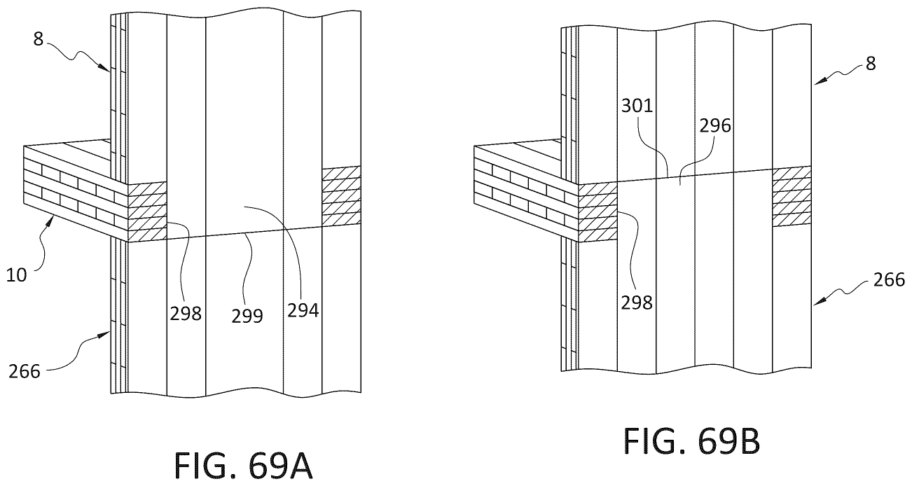

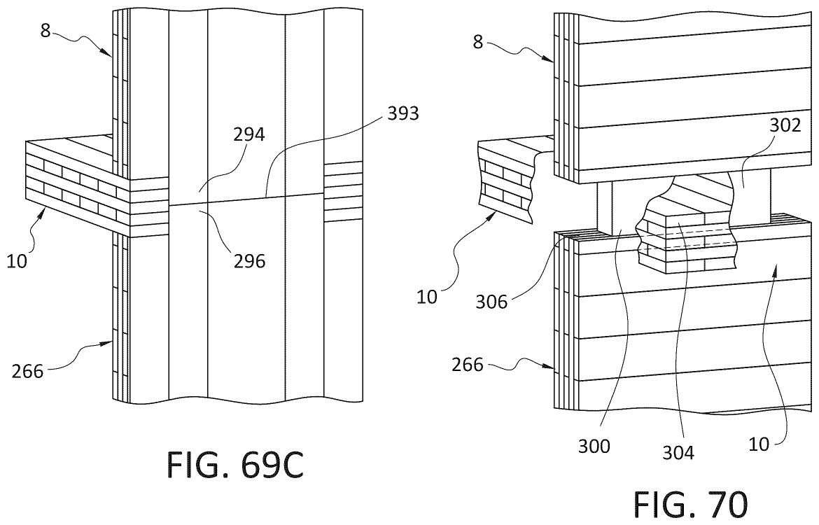

Referring to FIGS. 69A, 69B and 69C, a portion 294 of the upper wall 8 extends through the thickness of the floor 10 and bears on a top surface 299 of the lower wall 266. Alternatively, a bottom surface of the upper wall 10 bears on the lower wall 266 via a portion 296 of the lower wall 266 that extends through the thickness of the floor 10. The floor 10 includes an opening or cutout 298 through which the portion 294 or 296 extends. Still alternatively, the portions 294 and 296 may extend partway through the thickness of the floor 10 and bear one each other inside the floor at respective bottom and top surfaces 303 of the portions 294 and 296.

Referring to FIG. 70, the floor 10 extends on both sides of the walls 10 and 266. An opening 300 in the floor 10 receives a portion 302 of the wall 8 and a portion 304 of the wall 266. The portions 302 and 304 are reduced so as to create shoulders 306 on the respective walls 10 and 266. The shoulder 306 on the wall 266 advantageously provides support for the floor 10. The ends of the portions 302 and 304 bear on each other inside the thickness of the floor 10.

In the foregoing description for FIGS. 66A-70, while the floor 10 is shown extending on either side of the walls 8 and 266, it should be understood that the floor panel 10 may also terminate at the walls 10 and 266 using the same or similar structural relationships between the walls 10 and 266 and the floor 10.

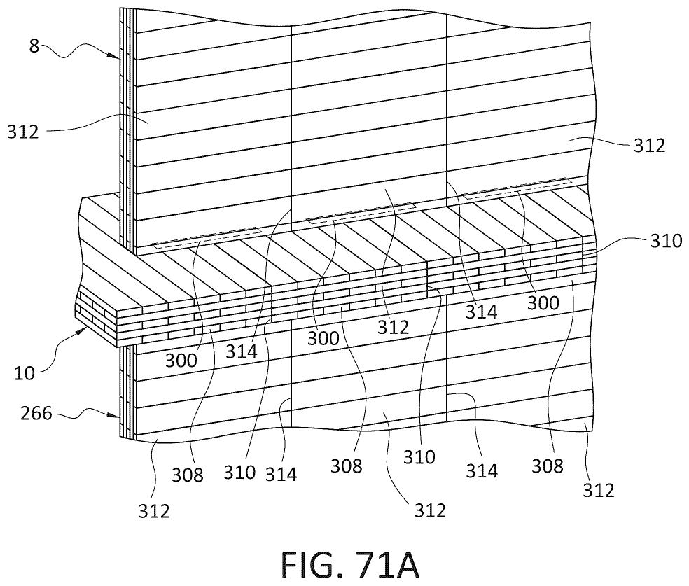

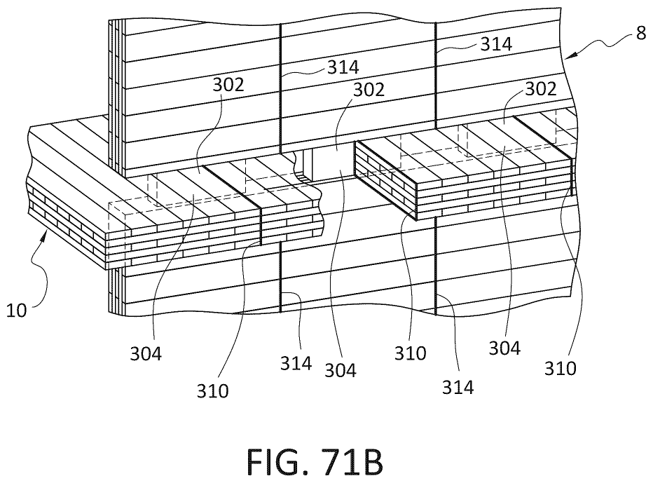

Referring to FIGS. 71A and 71B, the floor 10 is made of several panels 308 joined together at adjoining sides or seams 310. Similarly, the walls 8 and 266 are made of several panels 312 joined together at adjoining sides or seams 314. Each half of the openings 300 is advantageously made into the respective panels 308 from the seams 310.

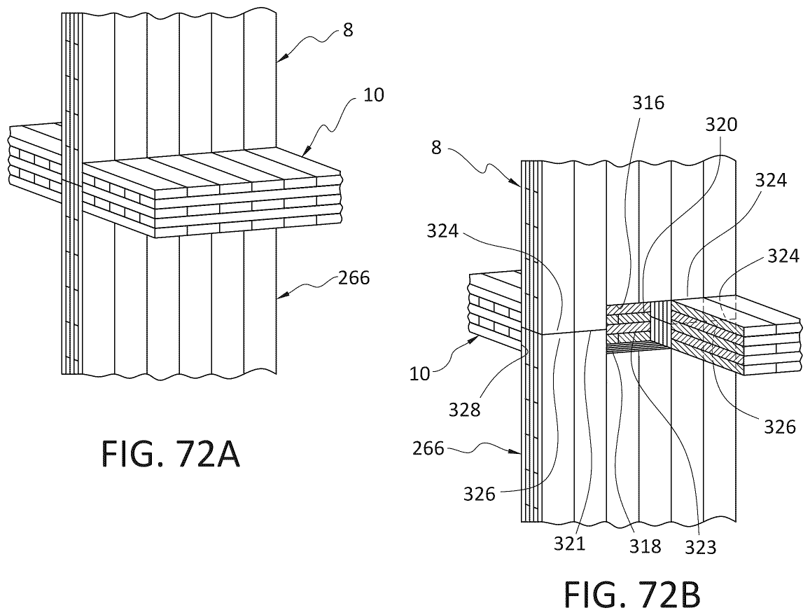

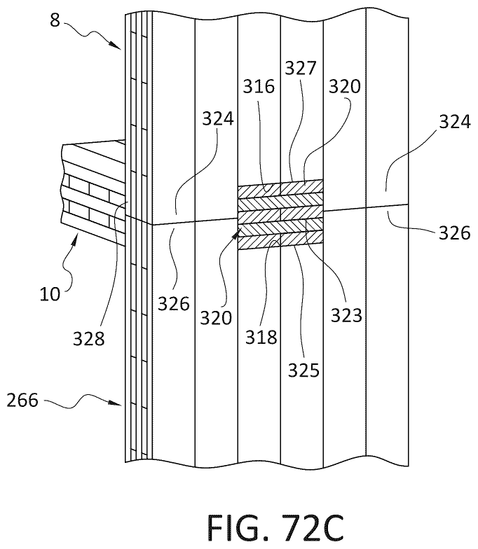

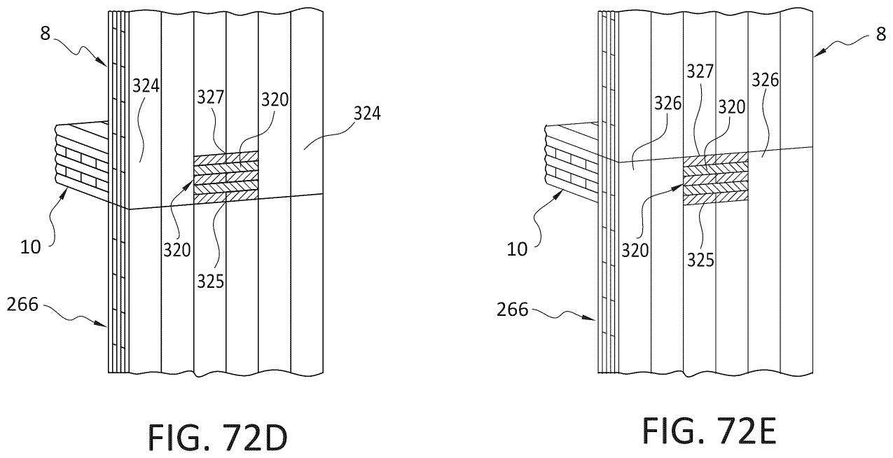

Referring to FIGS. 72A and 72B, the walls 8 and 266 have slots 316 and 318 that together form an opening 320 to receive a portion 322 of the floor 10. The wall 8 is supported by the wall 266 along respective edges 321. The slots 316 and 318 are preferably disposed in the intermediate portion of the end portions 324 and 326 of the walls 8 and 266. The floor 10 includes a portion 323 disposed in the opening 320 and slots 328 for receiving the end portions 324 and 326. The end portions 324 advantageously bear on the end portions 326. The portion 323 and the slots 328 are disposed in an intermediate portion of the floor 10.

For passageways in the upper wall 8 that need to continue to the lower wall 266, the passageway in the upper wall 8 may be aligned with the passageway in the lower wall 266 through the end portions 324 and 326.

Referring to FIG. 72C, the floor 10 includes an edge that abuts the walls 8 and 266. The portion 323 is a projection from the edge of the floor 10. The slots 328 are cutouts in the edge portion of the floor 10. The end portions 324 and 326 may meet within the thickness of the floor 10. The opening 320 includes a bottom edge 325 and a top edge 327. In the embodiment shown, the bottom edge 325 is below the top edge of the wall 266 and the top edge 327 is above the bottom edge of the wall 8.

Referring to FIG. 72D, the opening 320 may be disposed completely in the wall 8 so that the end portions 324 extend through the thickness of the floor 10 and bear on the wall 266. In this case, the bottom edge 325 of the opening 320 is defined by the top edge of the wall 266.

Referring to FIG. 72E, the opening 320 may be disposed completely in the wall 266 so that the end portions 326 extend through the thickness of the floor 10 to meet the wall 8. In this case, the bottom edge 325 of the opening 320 is below the top edge of the wall 266 and the top edge 327 of the opening 320 is defined by the bottom edge of the wall 8.

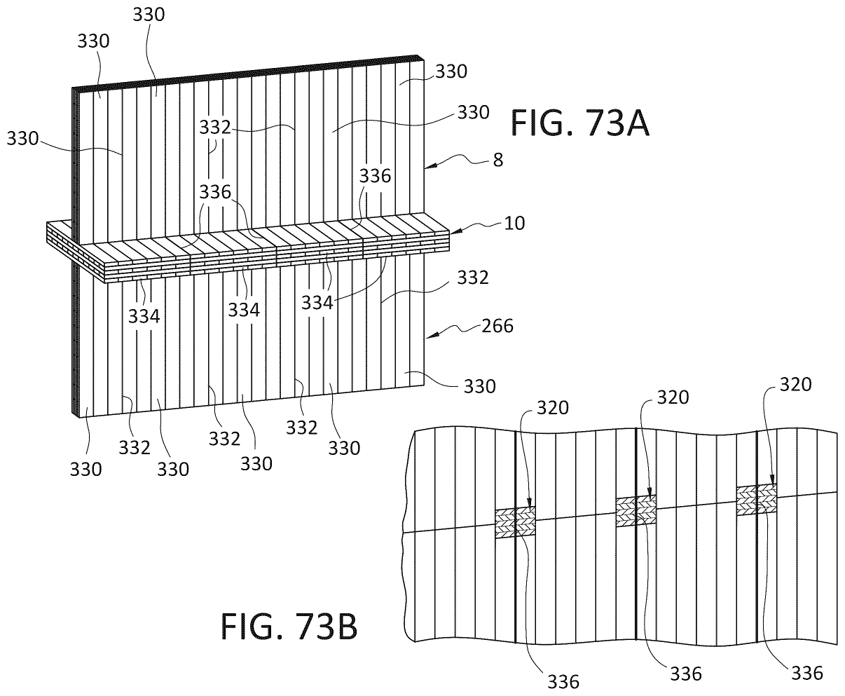

Referring to FIGS. 73A and 73B, the wall 8 is made up of several sections or panels 330 joined at the seams 332. Similarly, the wall 266 includes several sections or panels 330 joined at the seams 332. The floor 10 is also made up of several sections or panels 334 joined at the seams 336. The wall panels 330 are advantageously staggered with the floor panels 334 so that the seams 332 of the wall 8 and 266 do not line up with the seams 336 of the floor 10. The openings 320 are preferably disposed in the center of the wall panels 330 while the seams 336 of the floor 10 are received within the openings 330.

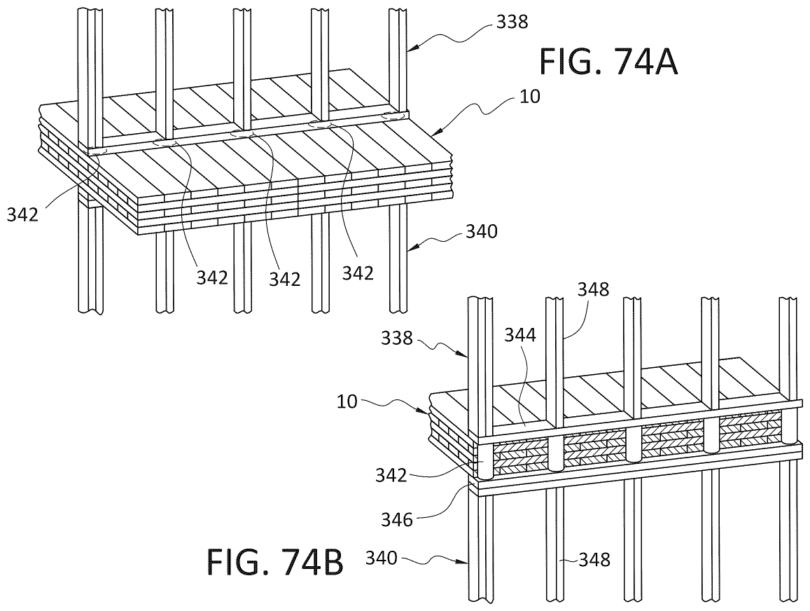

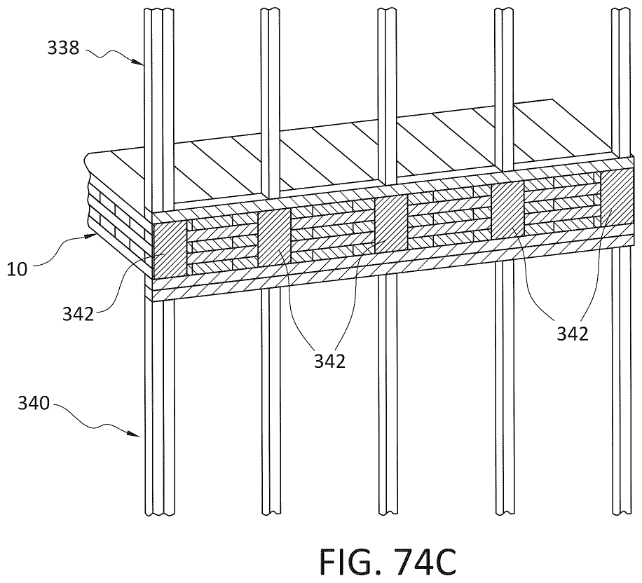

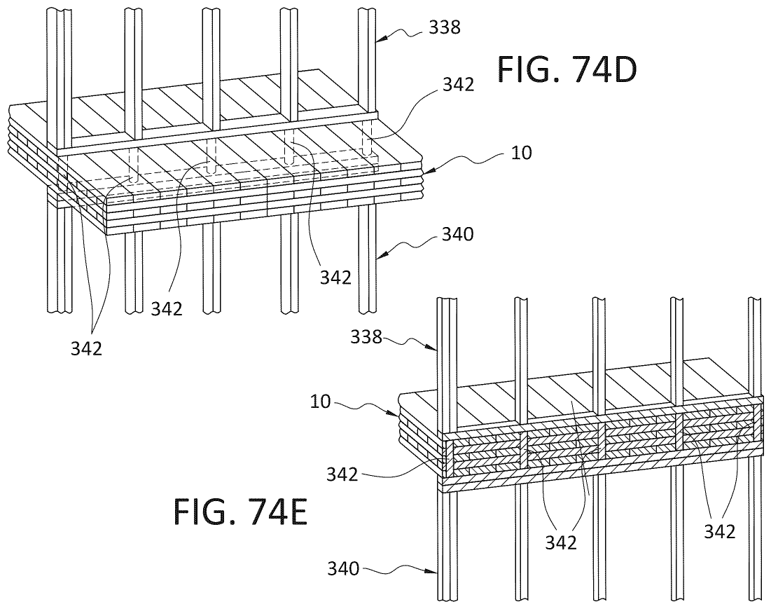

Referring to FIGS. 74A, 74B, 74C, 74D and 74E, compression forces from an upper stud wall 338 are transmitted to a lower stud wall 340 through engineered wood cylinders 342 embedded in the floor 10. The cylinders 342 may be made of other materials, such as hard wood, metal that have larger compressive capacities than the lumber boards that make up the CLT floor 10. The bottom plate 344 of the stud wall 338 and the top plates 346 of the stud wall 340 may also be made of engineered wood for greater compressive load capacities than the lumber used for the studs 348. The use of engineered wood advantageously provides for greater loading on the vertical studs 348, since loading parallel to grain is higher than loading perpendicular to grain. If the same wood species as the vertical studs were used for the bottom plate and the top plate, then compressive loading of stud wall will be limited to the capacity of the top plate and the bottom plate where loading is perpendicular to grain. The studs 348 in the stud wall 338 advantageously line up with the cylinders 342 and the studs 348 in the stud wall 340 so that the concentrated compressive forces from the studs 348 in the upper stud wall 338 are advantageously transferred to the studs 348 in the lower stud wall 340. The size of the cylinders 342 may be made larger or smaller (see FIGS. 74D and 74E) depending on the expected load and the compressive strength of the materials used for the cylinders 342.

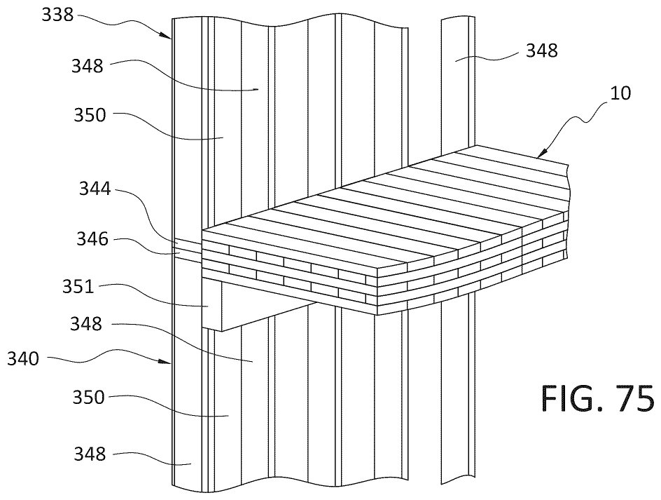

Referring to FIG. 75, the stud wall 338 is supported directly by the lower stud wall 340. Standard sheathing 350 is attached to the studs 348. A horizontal member 351 is operably attached to the studs 348 to provide support for the CLT floor 10. Compressive forces from the stud wall 338 is advantageously transferred directly to the lower stud wall 340 without going through the floor 10. Engineered wood may be used for the bottom plate 344 and the top plate 346.

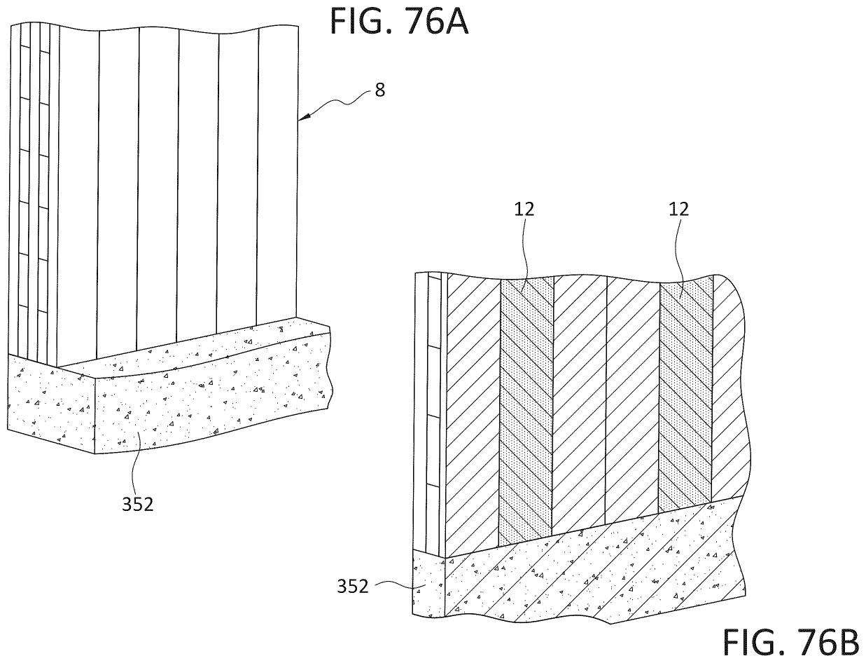

Referring to FIGS. 76A and 76B, the CLT wall 8 is supported by a concrete foundation 352. The wall 8 includes insert members 12 with bottom ends that bear directly on the foundation 352. The insert members 12 have compressive strength greater than those of the other lumber boards that make up the CLT wall 8. Other insert members 12 may be disposed inside the layers of the wall 8 to provide additional strength to the wall 8, as the expected loading requires. Accordingly, more load is carried by the insert members 12 than the other lumber boards, advantageously minimizing crushing of the bottom of the wall 8 due to the compressive load from above. The insert members 12 may be made of engineered lumber, metal, etc.

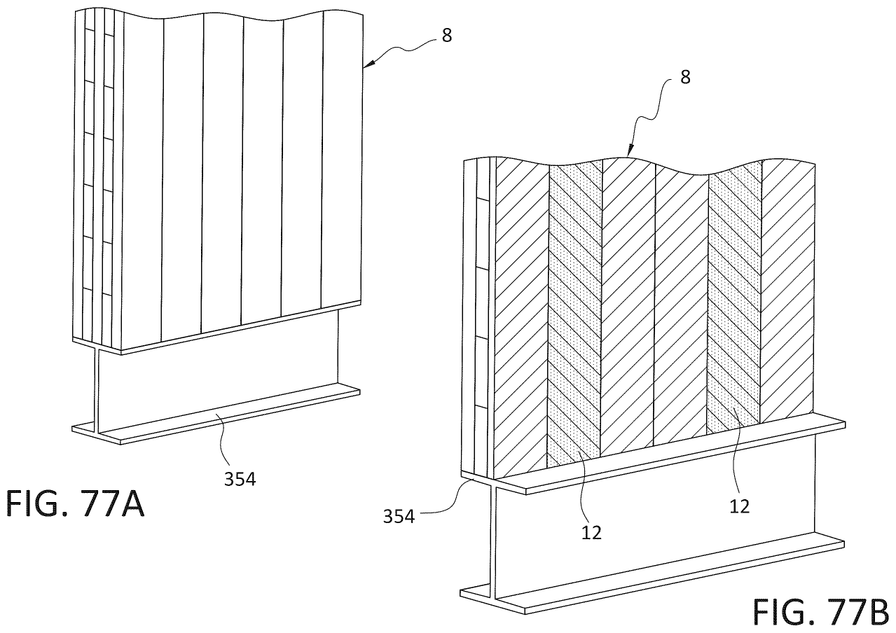

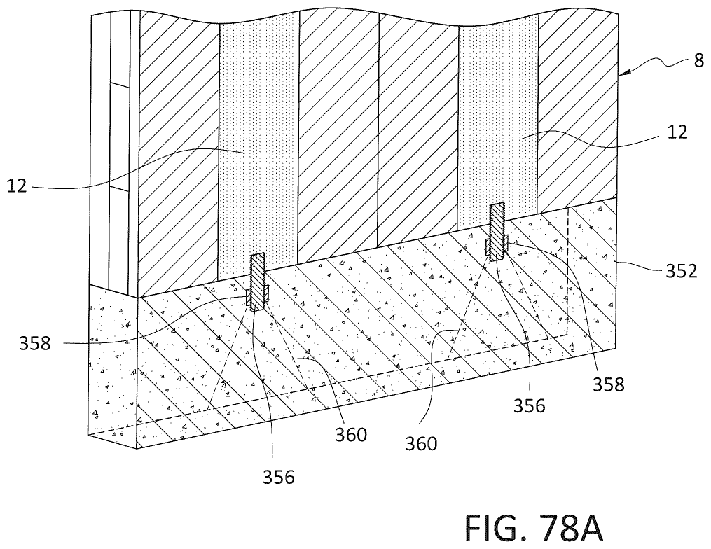

Referring to FIGS. 77A and 77B, the CLT wall 8 is supported by a steel beam 354. The insert members 12 have bottom ends that bear directly on the steel beam 354. Other insert members 12 may be disposed inside the layers of the wall 8 to provide additional strength to the wall 8, as the expected loading requires. The insert members 12 have compressive strength greater than those of the other lumber boards that make up the CLT wall 8. Accordingly, more load is carried by the insert members 12 than the adjacent lumber boards, advantageously minimizing crushing of the bottom of the wall 8 due to the compressive load from above. The insert members 12 may be made of engineered lumber, metal, etc.

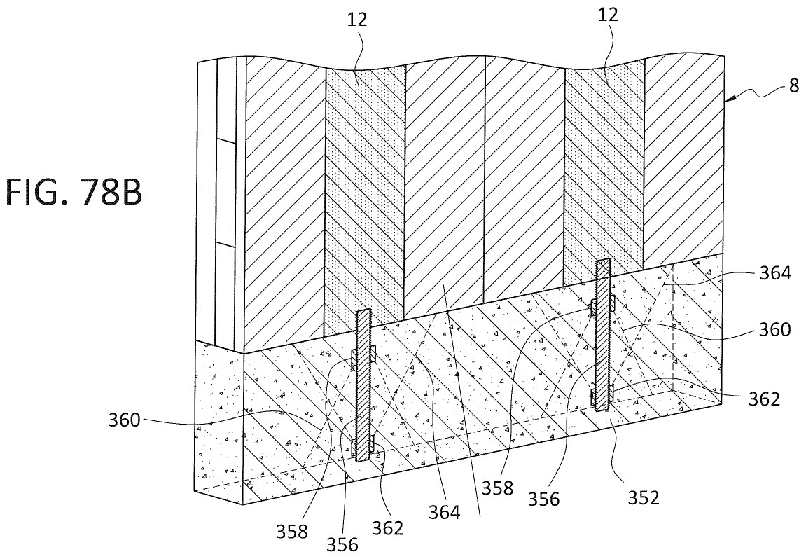

Referring to FIG. 78A, the insert members 12 are attached at their bottom ends to the foundation 352 with threaded studs 356 threaded to the insert members 12 and anchored with anchors 358, which may be nuts, metal plates or other anchors embedded in the concrete foundation 352 near the top to absorb compression loads. Locating the anchors 358 near the top of the foundation will advantageously provide a larger breakout or shear cone 360 when subjected to compression loading than if located toward the bottom.

Referring to FIG. 78B, the insert members 12 are attached at their bottom ends to the foundation 352 with longer threaded studs 356 provided with upper anchors 358 and lower anchors 362. The studs 356 are threaded to the insert members 12. The upper anchors 358 provide the breakout or shear cones 360 when the wall 8 is subjected to compressive loading. The lower anchors 362 provide the breakout or shear cones 364 when the wall 8 is subjected to lifting or tension loading.

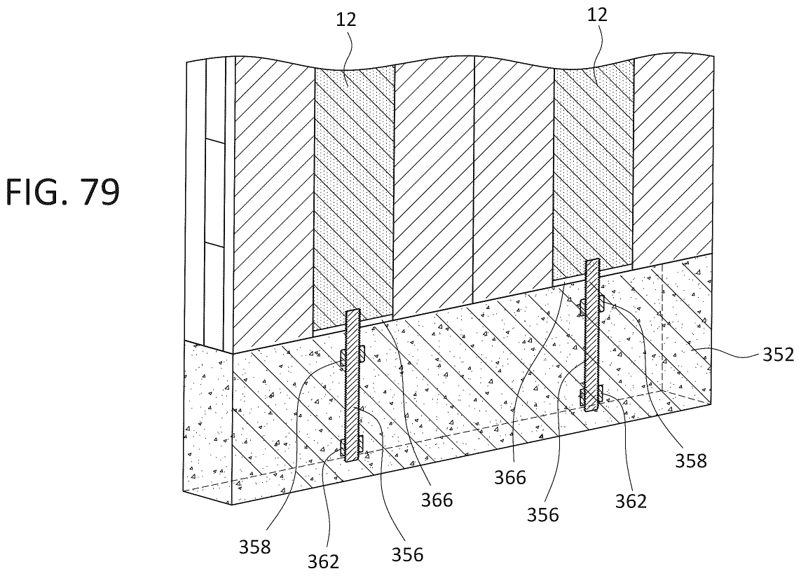

Referring to FIG. 79, the insert members 12 are not bearing directly on the foundation 352. A gap 366 is provided between the bottom of the insert members 12 and the foundation 352. Load is transferred directly from the insert members 12 to the threaded studs 356 and the anchors 358 and 362.

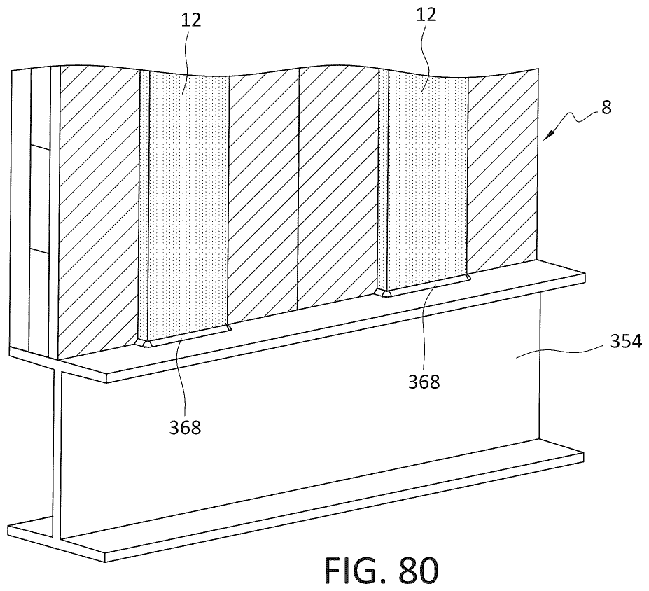

Referring to FIG. 80, the bottom ends of the insert members 12 are attached to the steel beam 354 with welds 368.

It should be understood that the walls and floor disclosed above that form part of a building may also incorporate passageways as described herein that interconnect together for routing of wires, pipes, conduits, etc. from a wall to a floor or vice versa.

The various features disclosed herein with particular embodiments of the insert members used in a CLT panel should be understood to be not limited to the particular combination shown but may be combined with the other embodiments of the insert members. A CLT panel may use one or more types of the insert members in combination. The CLT panels disclosed herein incorporating the insert members should be understood to be equally applicable as a wall panel or floor panel. Further, the wall panels may incorporate insert members that may be the same or different from the floor panels in terms of the types and location of the insert members.

While this invention has been described as having preferred design, it is understood that it is capable of further modifications, uses and/or adaptations following in general the principle of the invention and including such departures from the present disclosure as come within known or customary practice in the art to which the invention pertains, and as may be applied to the essential features set forth, and fall within the scope of the invention or the limits of the appended claims.

1. A cross-laminated timber panel, comprising:
a) a plurality of layers of lumber boards, each layer comprising a number of the lumber boards laid side-to-side pointing to a direction, each layer being disposed perpendicular to the direction of an adjoining layer; and
b) an insert member replacing one of the lumber boards, the insert member having a different material or configuration than the lumber boards.

2. The cross-laminated timber panel as in claim 1, wherein the insert member includes a rectangular tube.

3. The cross-laminated timber panel as in claim 2, wherein the rectangular tube is covered with wood veneer on two opposite sides.

4. The cross-laminated timber panel as in claim 2, wherein the rectangular tube is covered with wood veneer on all sides.

5. The cross-laminated timber panel as in claim 1, wherein the insert member includes a solid core material covered with wood veneer on at least two sides.

6. The cross-laminated timber panel as in claim 1, wherein the insert member includes a solid lumber with different material properties than the lumber boards.

7. The cross-laminated timber panel as in claim 1, wherein the insert member includes engineered lumber.

8. The cross-laminated timber panel as in claim 1, wherein the insert member includes plywood.

9. The cross-laminated timber panel as in claim 1, wherein the insert member includes wood plastic composite or carbon fiber block.

10. The cross-laminated timber panel as in claim 1, wherein:
a) the insert member includes a first member and a second member; and
b) the first member is oriented horizontally and the second member is oriented vertically.

11. The cross-laminated timber panel as in claim 1, wherein the at least one of the lumber boards is in an inner layer or outer layer of the plurality of layers.

12. The cross-laminated timber panel as in claim 1, wherein the at least one of the lumber boards is attached to adjacent lumber boards with bolts, screws or dowels.

13. A cross-laminated timber panel, comprising:
a) a plurality of layers of lumber boards, each layer comprising a number of lumber boards laid side-to-side pointing to a direction, each layer being disposed perpendicular to the direction of an adjoining layer; and
b) one of the lumber boards including a first passageway.

14. The cross-laminated timber panel as in claim 13, wherein the first passageway includes a trough along a length of the at least one of the lumber boards.

15. The cross-laminated timber panel as in claim 14, the trough includes a base wall and opposed first sidewall and second sidewall.

16. The cross-laminated timber panel as in claim 13, wherein the first passageway includes a first recess along a longitudinal edge of the one of the lumber boards.

17. The cross-laminated timber panel as in claim 16, wherein:
a) the first passageway includes a second recess along a longitudinal edge of a lumber board adjacent to the one of the lumber boards; and
b) the first recess and the second recess are disposed next to each other to create a trough.

18. The cross-laminated timber panel as in claim 13, wherein the first passageway includes a half-oblong groove.

19. The cross-laminated timber panel as in claim 13, wherein the first passageway includes a first half-circular groove along a longitudinal edge of the one of the lumber boards.

20. The cross-laminated timber panel as in claim 19, wherein:
a) the first passageway includes a second half-circular groove along a longitudinal edge of a lumber board adjacent to the one of the lumber boards; and
b) the first half-circular groove and the second half- circular groove are disposed next to each other to create a circular passageway.

21. The cross-laminated timber panel as in claim 13, wherein the first passageway includes a first V-shaped groove along a longitudinal edge of the one of the lumber boards.

22. The cross-laminated timber panel as in claim 21, wherein:
a) the first passageway includes a second V-shaped groove along a longitudinal edge of a lumber board adjacent to the one of the lumber boards; and
b) the first V-shaped groove and the second V-shaped groove are disposed next to each other to create a square passageway.

23. The cross-laminated timber panel as in claim 13, wherein the first passageway includes a first beveled surface along a longitudinal edge of the one of the lumber boards.

24. The cross-laminated timber panel as in claim 21, wherein:
a) the first passageway includes a second beveled surface along a longitudinal edge of a lumber board adjacent to the one of the lumber boards; and
b) the first beveled surface and the second beveled surface are disposed next to each other to create a triangular passageway.

25. The cross-laminated timber panel as in claim 13, wherein the first passageway is a circular passageway.

26. The cross-laminated timber panel as in claim 25, wherein:
a) the one of the lumber boards comprises a first half member and a second half member; and
b) a first half-circular groove is disposed in the first half member;
c) a second half-circular groove is disposed in the second half member; and
d) the first half-circular groove and the second half-circular groove are directed toward each other to form the circular passageway when the first half-member is joined to the second half-member.

27. The cross-laminated timber panel as in claim 13, wherein the first passageway is a rectangular passageway.

28. The cross-laminated timber panel as in claim 27, wherein:
a) the one of the lumber boards comprises a first half member and a second half member; and
b) a first rectangular groove is disposed in the first half member;
c) a second rectangular groove is disposed in the second half member; and
d) the first rectangular groove and the second rectangular groove are directed toward each other to form the rectangular passageway when the first half-member is joined to the second half-member.

29. The cross-laminated timber panel as in claim 13, wherein a second passageway intersects the first passageway.

30. The cross-laminated timber panel as in claim 29, wherein the second passageway is perpendicular to the first passageway.

31. The cross-laminated timber panel as in claim 29, wherein the first passageway and the second passageway are disposed on the same layer.

32. The cross-laminated timber panel as in claim 29, wherein the first passageway in a first layer and the second passageway is in a second layer next to the first layer.

33. The cross-laminated timber panel as in claim 29, wherein:
a) the first passageway in a first layer and a second layer next to the first layer; and
b) the second passageway is in the first layer and the second layer.

34. The cross-laminated timber panel as in claim 13, and further comprising a cable, pipe or a tie rod disposed in the first passageway.

35. A cross-laminated timber panel, comprising:
a) a plurality of layers of lumber boards, each layer comprising a number of lumber boards laid side-to-side pointing to a direction, each layer being disposed perpendicular to the direction of an adjoining layer;
b) a first passageway in a first layer; and
c) a second passageway is disposed transverse to the first passageway to intersect and connect with the first passageway.

36. The cross-laminated timber panel as in claim 35, wherein the second passageway is in the first layer.

37. The cross-laminated timber panel as in claim 35, wherein:
a) a first tube is disposed in the first passageway; and
b) a second tube is disposed in the second passageway.

38. The cross-laminated timber panel as in claim 35, wherein the second passageway is in a second layer adjacent to the first layer.

39. The cross-laminated timber panel as in claim 35, wherein:
a) the first passageway is disposed in a space vacated by a lumber board; and
b) the second passageway is a groove.

40. The cross-laminated timber panel as in claim 37, wherein the first tube and the second tube are made of foam.

41. The cross-laminated timber panel as in claim 35, wherein:
a) a first conduit is disposed in the first passageway; and
b) the first conduit is covered with foam.

42. The cross-laminated timber panel as in claim 35, wherein:
a) a conduit is disposed in the first passageway and the second passageway; and
b) the conduit is covered with foam.

43. The cross-laminated timber panel as in claim 37, wherein the first tube and the second tube are covered with foam.

44. The cross-laminated timber panel as in claim 1, wherein:
a) the plurality of layers includes a first outer layer; and
b) the at least one of the lumber boards includes a first insert member disposed in the first outer layer.

45. The cross-laminated timber panel as in claim 44, wherein:
a) the plurality of layers includes an inner layer; and
b) the at least one of the lumber boards includes a second insert member disposed in the inner layer, the second insert member is disposed transversely to the first insert member.

46. The cross-laminated timber panel as in claim 44, wherein:
a) the plurality of layers includes a second outer layer; and
b) the at least one of the lumber boards includes a second insert member disposed in the second outer layer.

47. The cross-laminated timber panel as in claim 46, wherein the first insert member and the second insert member each includes a lifting eye bolt or lifting eye pin.

48. The cross-laminated timber panel as in claim 1, wherein:
a) the plurality of layers includes an inner layer; and
b) the at least one of the lumber boards includes first insert member disposed in the inner layer; and
c) the first insert member includes nail plates for securing the first insert member to adjacent lumber boards.

49. The cross-laminated timber panel as in claim 48, wherein:
a) the first insert member includes first and second wider sides; and
b) the nail plates are disposed on the wider sides.

50. The cross-laminated timber panel as in claim 49, wherein the nail plates are wider than the wider sides.

51. The cross-laminated timber panel as in claim 50, wherein:
a) the nail plates include one side; and
b) the nail plates include spikes extending only from the one side.

52. A cross-laminated timber panel, comprising:
a) a plurality of layers of lumber boards, each layer comprising a number of lumber boards laid side-to-side pointing to a direction, each layer being disposed perpendicular to the direction of an adjoining layer; and
b) nail plates disposed between the layers to attach the layers to adjacent layers.

53. The cross-laminated timber panel as in claim 52, wherein:
a) the cross-laminated timber panel includes a width and a length; and
b) the nail plates extend the width and length of the cross-laminated timber panel.

54. A building, comprising:
a) a first wall made up of a plurality of layers of lumber boards, each layer comprising a number of lumber boards laid side-to-side pointing to a direction, each layer being disposed perpendicular to the direction of an adjoining layer, the first wall including a first insert member replacing one of the lumber boards, the first insert member having a greater compressive capacity than the lumber boards of the first wall;
b) a floor made up of a plurality of layers of lumber boards, each layer comprising a number of lumber boards laid side-to-side pointing to a direction, each layer being disposed perpendicular to the direction of an adjoining layer, the floor being disposed above the first wall;
c) a second wall made up of a plurality of layers of lumber boards, each layer comprising a number of lumber boards laid side-to-side pointing to a direction, each layer being disposed perpendicular to the direction of an adjoining layer, the second wall being disposed above the floor, the second wall including a second insert member having a greater compressive capacity than the lumber boards of the second wall; and
d) the floor including a member disposed perpendicular to the floor, the member having a greater compressive capacity than the lumber boards of the floor, the member being aligned and in contact with the first insert member and the second insert member to transfer loading from the second wall to the first wall via the member in the floor.

55. The building as in claim 54, wherein the member includes a column insert member joined to the first insert member and the second insert member with pins.

56. The building as in claim 55, wherein the pins are threaded.

57. The building as in claim 55, wherein:
a) a first pin is disposed in an opening in a top end of the first insert member and an opening in a bottom end of the column insert member; and
b) a second pin is disposed in an opening in a bottom end of the second insert member and an opening in a top end of the column insert member.

58. The building as in claim 57, wherein:
a) the first pin is threaded to the opening in the top end of the first insert member and the opening in the bottom end of the column insert member; and
b) the second pin is threaded in the opening in the bottom end of the second insert member and the opening in the top end of the column insert member.

59. The building as in claim 58, wherein:
a) the top end of the first insert member is spaced from the a bottom surface of the floor; and
b) the bottom end of the second insert member is spaced from a top surface of the floor.

60. The building as in claim 55, wherein the column insert includes a cylindrical member extending into a top end of the first insert member and a bottom end of the second insert member.

61. The building as in claim 54, wherein the member has the same or greater compressive strength as the first insert member or the second insert member.

62. The building as in claim 54, wherein the member includes a bearing area equal or greater than a bearing area of the top end of the first insert member or the bottom end of the second insert member.

63. The building as in claim 61, wherein the member is wood or metal.

64. A building, comprising:
a) a first wall made up of a plurality of layers of lumber boards, each layer comprising a number of lumber boards laid side-to-side pointing to a direction, each layer being disposed perpendicular to the direction of an adjoining layer, the first wall including a first insert member replacing one of the lumber boards, the first insert member having a greater compressive capacity than the lumber boards of the first wall, the first insert member including a top end;
b) a floor made up of a plurality of layers of lumber boards, each layer comprising a number of lumber boards laid side-to-side pointing to a direction, each layer being disposed perpendicular to the direction of an adjoining layer, the floor being disposed above the first wall; and
c) a second wall made up of a plurality of layers of lumber boards, each layer comprising a number of lumber boards laid side-to-side pointing to a direction, each layer being disposed perpendicular to the direction of an adjoining layer, the second wall being disposed above the floor, the second wall including a second insert member having a greater compressive capacity than the lumber boards of the second wall, the second insert member including a lower end engaging the top end of the first insert member, thereby to transfer the load from the second wall to the first wall via the first insert member and the second insert member.

65. The building as in claim 64, wherein the lower end of the second insert member extends across the floor to engage the top end of the first insert member.

66. The building as in claim 64, wherein the top end of the first insert member extends across the floor to engage the bottom end of the second insert member.

67. The building as in claim 64, wherein:
a) the floor includes a thickness; and
b) the top end of the first insert member and the bottom end of the second insert member engage within the thickness of the floor.

68. A building, comprising:
a) a first wall made up of a plurality of layers of lumber boards, each layer comprising a number of lumber boards laid side-to-side pointing to a direction, each layer being disposed perpendicular to the direction of an adjoining layer;
b) a floor made up of a plurality of layers of lumber boards, each layer comprising a number of lumber boards laid side-to-side pointing to a direction, each layer being disposed perpendicular to the direction of an adjoining layer, the floor being disposed above the first wall;
c) a second wall made up of a plurality of layers of lumber boards, each layer comprising a number of lumber boards laid side-to-side pointing to a direction, each layer being disposed perpendicular to the direction of an adjoining layer, the second wall being disposed above the floor;
d) the floor including an opening; and
e) a first portion of the first wall supporting a second portion of the second wall through the opening.

69. The building as in claim 68, wherein the first portion of the first wall extends through the opening.

70. The building as in claim 68, wherein the second portion of second wall through the opening.

71. The building as in claim 68, wherein the first portion and the second portion extend into the opening.

72. A building, comprising:
a) a first wall made up of a plurality of layers of lumber boards, each layer comprising a number of lumber boards laid side-to-side pointing to a direction, each layer being disposed perpendicular to the direction of an adjoining layer, the first wall including a top edge;
b) a second wall made up of a plurality of layers of lumber boards, each layer comprising a number of lumber boards laid side-to-side pointing to a direction, each layer being disposed perpendicular to the direction of an adjoining layer, the second wall being disposed above the floor, the second wall including a bottom edge supported on the top edge of the first wall to define a combined wall;
c) the combined wall including an opening;
d) a floor made up of a plurality of layers of lumber boards, each layer comprising a number of lumber boards laid side-to-side pointing to a direction, each layer being disposed perpendicular to the direction of an adjoining layer; and
e) the floor including a portion received in the opening, the floor including a slot or cutout on each side of the portion to receive the combined wall.

73. The building as in claim 72, wherein the portion is disposed in an intermediate portion of the floor.

74. The building as in claim 72, wherein:
a) the floor includes an edge abutting the first wall and the second wall; and
b) the portion is a projection from the edge.

75. The building as in claim 72, wherein the opening includes a bottom edge defined by the top edge of the first wall.

76. The building as in claim 72, wherein the opening includes a top edge defined by the bottom edge of the second wall.

77. The building as in claim 72, wherein:
a) the opening includes a bottom edge disposed below the top edge of the first wall; and
b) the opening includes a top edge disposed above the bottom edge of the second wall.

78. A building, comprising:
a) a lower stud wall;
b) a floor made up of a plurality of layers of lumber boards, each layer comprising a number of lumber boards laid side-to-side pointing to a direction, each layer being disposed perpendicular to the direction of an adjoining layer, the floor being disposed above the first wall, the floor is disposed above the lower stud wall;
c) an upper stud wall disposed above the floor; and
d) the floor including a plurality of members extending through a thickness of the floor, the member having larger compressive capacities than the lumber boards of the floor, the members being aligned with the upper stud wall and the lower stud wall, thereby to transfer load from the upper stud wall to the lower stud wall through the members.

79. The building as in claim 78, wherein the members include engineered wood.

80. The building as in claim 79, wherein the members are cylindrical.

81. A building, comprising:
a) a lower stud wall including a top plate and vertical studs attached to the top plate;
b) an upper stud wall including a bottom plate and vertical studs attached to the bottom plate;
c) the bottom plate of the upper stud wall is disposed on the top plate of the lower stud wall;
d) a horizontal member attached to the vertical studs; and
e) a floor made up of a plurality of layers of lumber boards, each layer comprising a number of lumber boards laid side-to-side pointing to a direction, each layer being disposed perpendicular to the direction of an adjoining layer, the floor being disposed above the first wall, the floor is by the horizontal member.

82. The building as in claim 81, wherein the top plate and the bottom plate include engineered wood.

83. A building, comprising:
a) a foundation;
b) a plurality of layers of lumber boards, each layer comprising a number of the lumber boards laid side-to-side pointing to a direction, each layer being disposed perpendicular to the direction of an adjoining layer; and
c) an insert member replacing one of the lumber boards, the insert member having greater compressive strength than the lumber boards, the insert member including a bottom end operably supported by the foundation.

84. The building as in claim 83, wherein:
a) the foundation includes concrete;
b) a threaded stud includes one end attached to the bottom end of the insert member and another end buried in the concrete.

85. The building as in claim 84, wherein an anchor is attached to the another end.

86. The building as in claim 85, wherein the anchor includes a nut.

87. The building as in claim 84, wherein:
a) the another end includes upper portion and a lower portion;
b) a first anchor is attached to upper portion; and
c) a second anchor is attached to the lower portion.

88. The building as in claim 84, wherein the bottom end of the insert member is spaced from the foundation.

89. The building as in claim 83, wherein:
a) the foundation includes a steel beam; and
b) the insert member is metallic welded to the steel beam.
